(19) United States
(12) Patent Application Publication
(10) Pub. No.: US 2026/0349637 A1
(43) Pub. Date: Nov. 5, 2026

(54) SYSTEM AND METHOD OF OPERATIVELY COUPLING AN AUGMENTED/VIRTUAL REALITY CONTROL MODULAR COMPUTING DEVICE VIA A SECURE POWER AND DATA TRANSFER CONNECTION WITH A DOCKING STATION OR MOBILE CLIP DEVICE FOR PLURAL USAGES

(71) Applicant: Dell Products LP, Round Rock, TX (US)

(72) Inventors: Gerald Rene Pelissier, Santa Clara, CA (US); Loo Shing Tan, Singapore (SG); Michiel Sebastiaan Emanuel Petrus Knoppert, Amsterdam (NL)

(73) Assignee: Dell Products LP, Round Rock, TX (US)

(21) Appl. No.: 19/194,845

(22) Filed: Apr. 30, 2025

(51) Int. Cl. G06F 3/14; G09G 3/00

(52) U.S. Cl. CPC G06F 3/14; G09G 3/001; G09G 2330/045

(57) ABSTRACT

An augmented/virtual reality (AR/VR) control modular computing device comprising a hardware processor disposed in a housing that includes a secure mating channel formed into one side for slidingly receiving a secure mating channel formed on an AR/VR control modular computing device docking station or on an AR/VR glasses clip device for generating AR or VR projected images for display within operatively coupled AR/VR glasses. A secure connector port spring-loaded and actuatable through a port opening into the secure mating channel such that vertical alignment between the port opening and a port receiving channel of the secure connector pin mount in the secure mating rail forces movement of the secure connector pin port housing to operatively couple with the secure connector pin mount to electrically and communicatively couple the AR/VR control modular computing device to the AR/VR control modular computing device docking station or to the AR/VR glasses mobile clip device.

### FIELD OF THE DISCLOSURE

The present disclosure generally relates to augmented reality (AR) or virtual reality (VR) glasses or headsets that operatively couple with an information handling system to perform external displays for the information handling system. The present disclosure more specifically relates to a system and method for securely mating an AR/VR control modular computing device acting as the information handling system to generate images for display via operatively connected AR/VR glasses with interchangeable operative coupling to a mobile clip or a docking station contributing additional processing power for plural uses, and for cooling the AR/VR control modular computing device via the secure mating connection formed thereby.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be operatively or wirelessly coupled to a digital display device, such as AR/VR glasses, for output of images or sound of digital media for a user.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an augmented reality/virtual reality (AR/VR) control modular computing device executing machine readable code instructions to generate and orchestrate the display of AR/VR images via operably connected AR/VR glasses and interchangeably couplable with a AR/VR glasses mobile clip device or a docking station according to an embodiment of the present disclosure;

FIG. 2 is a block diagram illustrating an AR/VR control modular computing device docking station couplable with an AR/VR control modular computing device for augmenting hardware processing resources and providing thermal cooling according to an embodiment of the present disclosure;

FIG. 3A is a graphical diagram illustrating an AR/VR control modular computing device docking station operably connected to AR/VR glasses and to an AR/VR control modular computing device according to an embodiment of the present disclosure;

FIG. 3B is a graphical diagram illustrating an AR/VR control modular computing device docking station for facilitating control of AR/VR glasses and an operably connected external augmented hardware processor device by an operably connected AR/VR control modular computing device according to an embodiment of the present disclosure;

FIG. 3C is a graphical diagram illustrating an AR/VR control modular computing device docking station for facilitating control of one or more operably connected input/output devices by an operably connected AR/VR control modular computing device according to an embodiment of the present disclosure;

FIG. 3D is a graphical diagram illustrating an AR/VR control modular computing device docking station with integrated digital display device for facilitating control of one or more operably connected input/output devices by an operably connected AR/VR control modular computing device during operation of AR/VR glasses according to an embodiment of the present disclosure;

FIG. 3E is a graphical diagram illustrating an AR/VR glasses mobile clip device operably connected to AR/VR glasses and to an AR/VR control modular computing device for mobile use of the AR/VR glasses according to an embodiment of the present disclosure;

FIG. 4 is a graphical diagram illustrating an AR/VR control modular computing device forming a secure connection via a secure mating channel with a secure mating rail on either an AR/VR control modular computing device docking station or an AR/VR glasses mobile clip device according to an embodiment of the present disclosure;

FIG. 5A is an exploded view graphical diagram illustrating a stack up of components of an AR/VR control modular computing device secure connector port housed within an AR/VR control modular computing device and a reciprocal secure connector pin mount of either an AR/VR control modular computing device docking station or an AR/VR glasses mobile clip device according to an embodiment of the present disclosure;

FIG. 5B is a top view graphical diagram illustrating a housing for an AR/VR control modular computing device for forming a secure operative coupling with either an AR/VR control modular computing device docking station or an AR/VR glasses mobile clip device according to an embodiment of the present disclosure;

FIG. 5C is a first cross-sectional view graphical diagram illustrating a portion of an AR/VR control modular computing device secure connector port disposed beneath a docking release button in an unlocked and disconnected position according to an embodiment of the present disclosure;

FIG. 5D is a second cross-sectional view graphical diagram illustrating a portion of an AR/VR control modular computing device secure connector port aligned with a port receiving channel of either an AR/VR control modular computing device docking station or an AR/VR glasses mobile clip device that is placed in an unlocked and disconnected position according to an embodiment of the present disclosure;

FIG. 5E is a first cross-sectional view graphical diagram illustrating a portion of an AR/VR control modular computing device secure connector port disposed beneath a docking release button in a locked and connected position according to an embodiment of the present disclosure;

FIG. 5F is a second cross-sectional view graphical diagram illustrating a portion of an AR/VR control modular computing device secure connector port aligned with a port receiving channel of either an AR/VR control modular computing device docking station or an AR/VR glasses mobile clip device that is placed in a locked and connected position according to an embodiment of the present disclosure;

FIG. 6A is a graphical diagram illustrating an AR/VR glasses mobile clip device housing a retractable cable for operably connecting to AR/VR glasses during mobile use of the AR/VR glasses according to an embodiment of the present disclosure;

FIG. 6B is a graphical diagram illustrating an AR/VR glasses mobile clip device housing a retracted and magnetically secured cable stowed in a channel along the housing of the AR/VR glasses mobile clip device for storage according to an embodiment of the present disclosure;

FIG. 6C is a graphical diagram illustrating a carrying case for housing an AR/VR glasses mobile clip device, an AR/VR control modular computing device, and AR/VR glasses according to an embodiment of the present disclosure;

FIG. 7 is a flow diagram illustrating a method of securely connecting and disconnecting AR/VR control modular computing device secure connector port of an AR/VR control modular computing device with either an AR/VR control modular computing device docking station or an AR/VR glasses mobile clip device according to an embodiment of the present disclosure; and

FIG. 8 is a flow diagram illustrating a method of thermally regulating an AR/VR control modular computing device via an operatively coupled AR/VR control modular computing device docking station cooling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

As computing processing capabilities grow, so too does a need for more room to display content for user interaction, such as across a plurality of digital display devices, for example. Another solution to such a need is to combine digital display devices with augmented reality or virtual reality (AR/VR) glasses that can further display holographic projected images of digital content, either in combination with, or in place of digital display devices such as computer monitors. Simultaneously, changes in working environments require that users be flexible to work in different locales, such as within the office, the home, public spaces, or on the move. Users desire the same computing experience and level of privacy that they enjoy in more controlled environments, such as their home or their office, across each of these potential working locales. Use of AR/VR glasses can provide private, repeatable, location independent user experiences, and relieve physical world limitations, such as screen sizes of physical screens.

Using AR/VR glasses allows users to organize a virtual workspace in the space around themselves, projected on top of the real world. Interactions in this workspace may also use familiar peripherals such as a keyboard, touchpad, and a mouse, for easy adoption and support for existing applications. AR/VR glasses further allow users to visualize their workspace in a format only viewable by the user themselves, allowing them to work, or enjoy a movie in privacy anywhere. Embodiments of the present disclosure allow for such portability and security by providing an ecosystem of devices that include AR/VR glasses, an AR/VR glasses mobile clip device for mobile use of the AR/VR glasses, and an AR/VR control modular computing device for generating and orchestrating the display of digital content within the AR/VR glasses. Each of these devices may be stored in a single carrying case. Further, the AR/VR glasses mobile clip device may include a retractable and magnetically securable cord for connecting the AR/VR glasses to the AR/VR glasses mobile clip device and a secure connector for slidable attachment and detachment of the AR/VR glasses mobile clip device to the AR/VR control modular computing device. Such a reciprocal secure connector within the AR/VR control modular computing device may further allow for slidable attachment and detachment of an AR/VR control modular computing device docking station for additional operable connection of the AR/VR control modular computing device to additional input/output devices, cooling mechanisms, or external augmented hardware processor devices to increase productivity of the AR/VR control modular computing device.

The AR/VR control modular computing device in embodiments herein may incorporate a secure mating channel housing an AR/VR control modular computing device secure connector port with a secure connector pin port housing for insertion of a secure mating rail incorporated within the housing of the AR/VR glasses mobile clip device or the AR/VR control modular computing device docking station. A user may slide the secure mating rail into the secure mating channel of the AR/VR control modular computing device until a port opening in the secure mating channel aligns with a port receiving channel in the secure mating rail. Such an alignment may allow springs attached to the secure connector pin port housing of an AR/VR control modular computing device secure connector port to push the secure connector pin port housing into the port receiving channel, inhibiting horizontal movement between the secure connector pin port housing and a secure connector pin mount housed within the port receiving channel. In other words, the user may insert the secure mating rail into the secure mating channel of the AR/VR control modular computing device until the secure connector pin port housing of the AR/VR control modular computing device secure connector port at the secure mating channel drops into place within the secure mating rail, holding the position of the AR/VR control modular computing device with respect to either the AR/VR glasses mobile clip device or the AR/VR control modular computing device docking station in various embodiments herein.

Further, such an alignment may push pin contacts within the secure connector pin mount into electrically conductive contact with pin ports within the secure connector pin port housing of the AR/VR control modular computing device secure connector port. This may complete a power or data transfer connection, such as a Universal Serial Bus (USB-C) connection between AR/VR control modular computing device and AR/VR glasses mobile clip device or AR/VR control modular computing device docking station. In embodiments herein, dedicated configuration channel (CC) lines may be created by pin contacts coming into electrically conductive contact with pin ports to allow the AR/VR control modular computing device to authenticate the mated AR/VR glasses mobile clip device or the mated AR/VR control modular computing device docking station. This may be done using USB-C standard or proprietary authentication procedures, for example. Power and data transfer between the AR/VR control modular computing device and the mated AR/VR glasses mobile clip device or the mated AR/VR control modular computing device docking station may only be allowed in embodiments herein upon successful authentication using such methods.

When the user wishes to change locations, she may press down on a docking release button housed within the AR/VR control modular computing device to slide the AR/VR control modular computing device away from the currently mated AR/VR control modular computing device docking station or currently mated AR/VR glasses mobile clip device. Such downward pressure on the docking release button in embodiments herein may cause a flexible hinge within the secure mating channel to lift the secure connector pin port housing out of the port receiving channel in the secure mating rail, allowing sliding movement between the secure connector pin port housing and the secure connector pin mount to physically disconnect the AR/VR control modular computing device from the AR/VR glasses mobile clip device or AR/VR control modular computing device docking station. Further, such movement of the secure connector pin port housing out of the port receiving channel may also move the pin contacts out of electrically conductive contact with the pin ports to disable the power and data transfer connection.

In some embodiments herein, the AR/VR control modular computing device docking station may comprise an AR/VR control modular computing device cooling docking station that uses the thermal pathway formed by the connection between the secure mating rail and the secure mating channel to dissipate heat from the AR/VR control modular computing device across the AR/VR control modular computing device secure connector port and maximize its performance. Upon mating of the secure mating rail of the AR/VR control modular computing device cooling docking station and the secure mating channel of the AR/VR control modular computing device to establish a secure power and data transfer connection via the AR/VR control modular computing device secure connector port, a hardware processor or controller of the AR/VR control modular computing device cooling docking station may execute machine readable code instructions of a docking station adaptable cooling system to determine an AR/VR control modular computing device preferred operating temperature range, as stored in a profile for the identified device at the AR/VR control modular computing device cooling docking station.

The hardware processor or controller of the AR/VR control modular computing device cooling docking station may also execute machine readable code instructions of the docking station adaptable cooling system to request and receive from the AR/VR control modular computing device a temperature reading from a temperature sensor at the AR/VR control modular computing device. If the temperature reading is above the preferred range in embodiments herein, the hardware processor or controller of the AR/VR control modular computing device cooling docking station may execute machine readable code instructions of the docking station adaptable cooling system to apply direct current (DC) voltage to a thermal control module, such as a Peltier thermal element. Application of such a DC voltage in embodiments herein may cause heat to transfer from the interior of the AR/VR control modular computing device, through the secure connection between the secure mating rail and the secure mating channel, to a heat sink operably connected to the secure connector pin mount cable within the secure mating channel, and to cooling ribs of the thermal control module for dissipation to the air surrounding the AR/VR control modular computing device cooling docking station. In such a way, the secure connection formed by mating of the secure mating channel of the AR/VR control modular computing device and the secure mating rail of either the AR/VR glasses mobile clip device or AR/VR control modular computing device docking station in embodiments herein may provide the dual purposes of secured power and data transfer between mated and authenticated devices, and thermal management of the AR/VR control modular computing device for maximized performance.

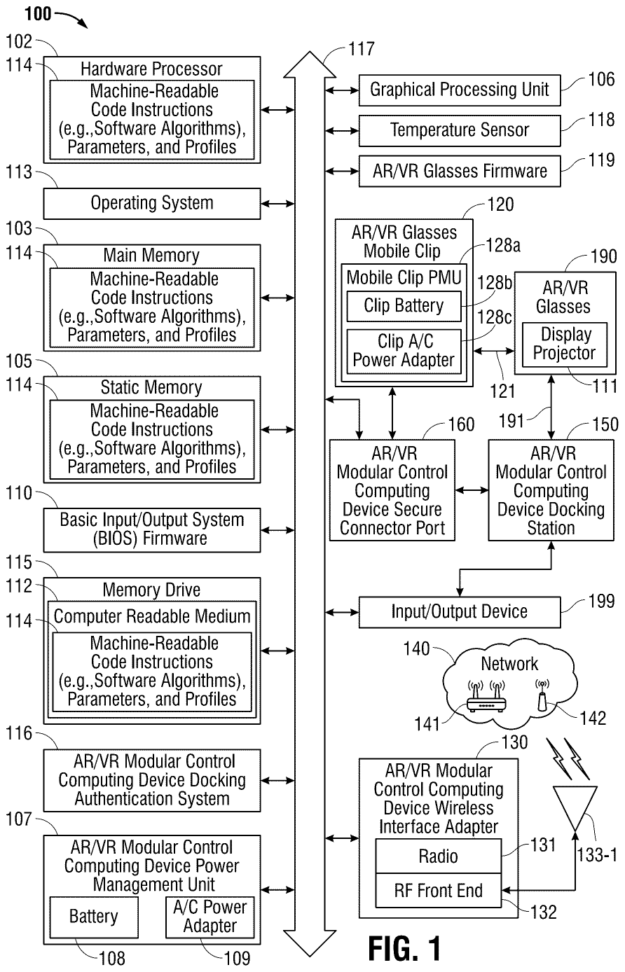

Turning now to the figures, FIG. 1 illustrates an information handling system 100 similar to the information handling systems according to several aspects of the present disclosure. An ecosystem of devices are described herein, which include AR/VR glasses 190, an AR/VR glasses mobile clip device 120 for mobile use of the AR/VR glasses 190, and an AR/VR control modular computing device 100 for generating and orchestrating the display of digital content within the AR/VR glasses 190 using the display projector 111. The AR/VR control modular computing device 100 may operatively couple with either the AR/VR glasses mobile clip device 120 for mobile use, or with an AR/VR control modular computing device docking station 150 for stationary or desktop use and to provide enhanced hardware processing resources and thermal control in embodiments herein.

The AR/VR glasses 190 in an embodiment may be operatively coupled to the AR/VR glasses mobile clip device 120, via a data and power transfer cord 121 (e.g., Universal Serial Bus (USB)-C cord). In some embodiments, AR/VR glasses mobile clip device 120 may further be operatively coupled to the AR/VR control modular computing device 100 via an AR/VR control modular computing device secure connector port 160 formed in the housing of the AR/VR control modular computing device 100. The AR/VR control modular computing device secure connector port 160 is actuatable into a secure mating channel in the housing of the AR/VR control modular computing device 100 in some embodiments or on a secure mating rail in other embodiments. In an example embodiment, the AR/VR control modular computing device secure connector port 160 actuated into the secure mating channel may engage with a secure connector pin mount on a secure mating rail of the AR/VR glasses mobile clip device 120 or on the AR/VR control modular computing device docking station 150. The AR/VR control modular computing device 100 engages with either the AR/VR control modular computing device docking station 150 or the AR/VR glasses mobile clip device 120 through slidable attachment and detachment with the secure mating channel and the reciprocal secure mating rail. In embodiments herein, the secure mating rail slides into the secure mating channel of the AR/VR control modular computing device 100 until the secure connector pin mount aligns with the AR/VR control modular computing device secure connector port being urged into the secure mating channel. In this way, power and communication operative coupling may be established between the AR/VR glasses mobile clip device 120 or the AR/VR control modular computing device docking station 150 and the AR/VR control modular computing device 100 in embodiments herein.

The AR/VR glasses 190 in an embodiment may also be operatively coupled to the AR/VR control modular computing device docking station 150, via a data and power transfer cord 191 (e.g., Universal Serial Bus (USB)-C cord) during stationary or desktop usage. The AR/VR control modular computing device docking station 150 may further be operatively coupled to the AR/VR control modular computing device 100 via the AR/VR control modular computing device secure connector port 160 formed through slidable attachment and detachment of the AR/VR control modular computing device docking station 150 to the AR/VR control modular computing device 100. In this way, the AR/VR control modular computing device docking station 150 and/or the AR/VR control modular computing device 100 may operate to control and provide hardware processing resources to the AR/VR glasses 190. The AR/VR control modular computing device docking station 150 in an embodiment may be operably connected to one or more external input/output devices 199 via wired or wireless connection, for example. The AR/VR control modular computing device 100 in an embodiment may draw power via the AR/VR control modular computing device secure connector port 160 formed by mating with the AR/VR control modular computing device docking station 150, or by application of DC voltage via the A/C power adapter 109 or battery 108. The AR/VR glasses 190 in an embodiment may be powered directly via the USB-C cord 191 from the AR/VR control modular computing device docking station 150 or from the AR/VR glasses mobile clip device 120 via cord 121 and either clip battery 128b or clip A/C power adapter 128c.

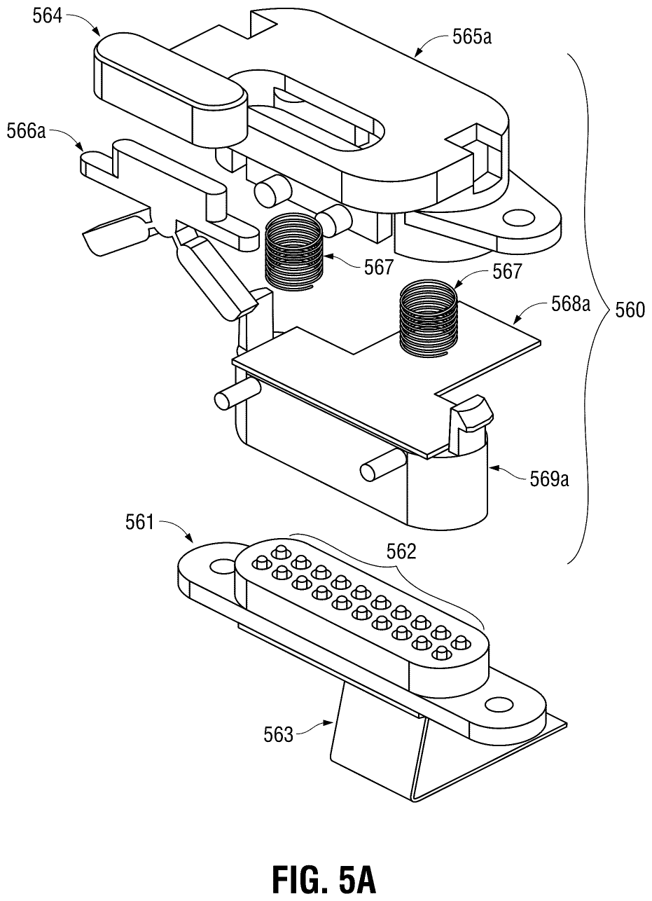

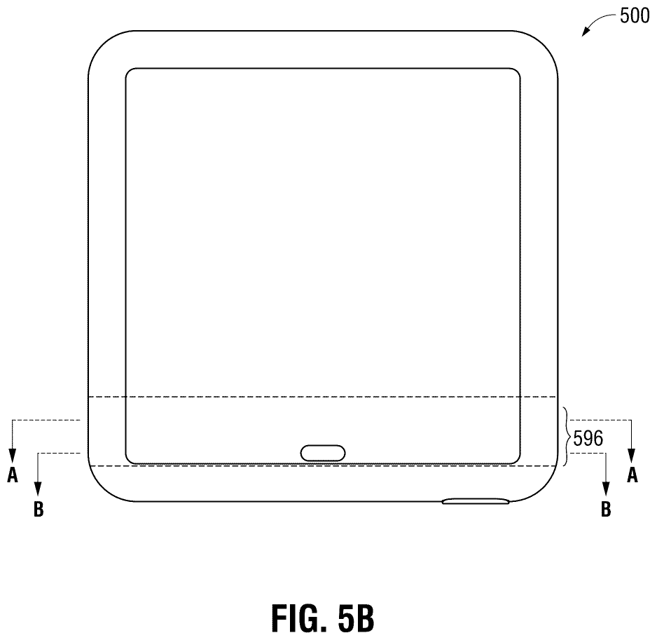

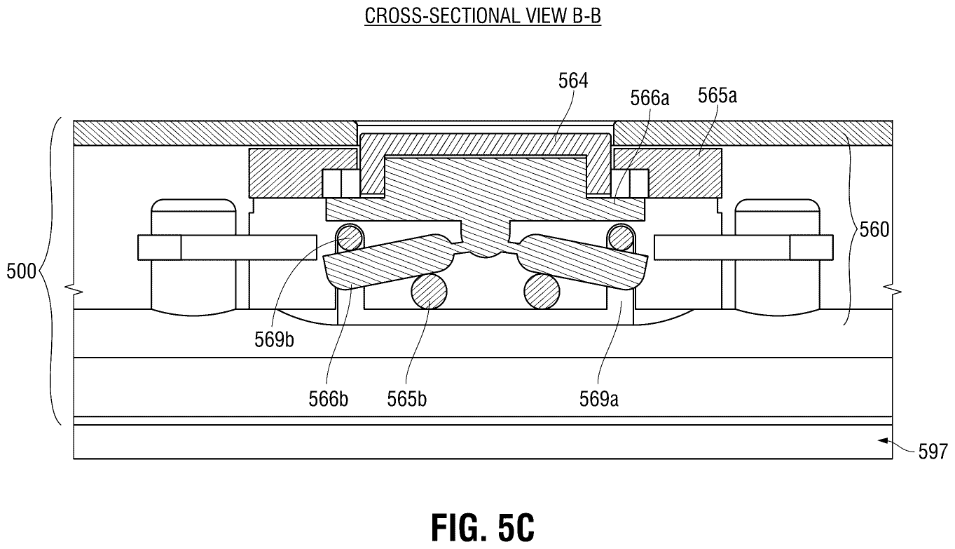

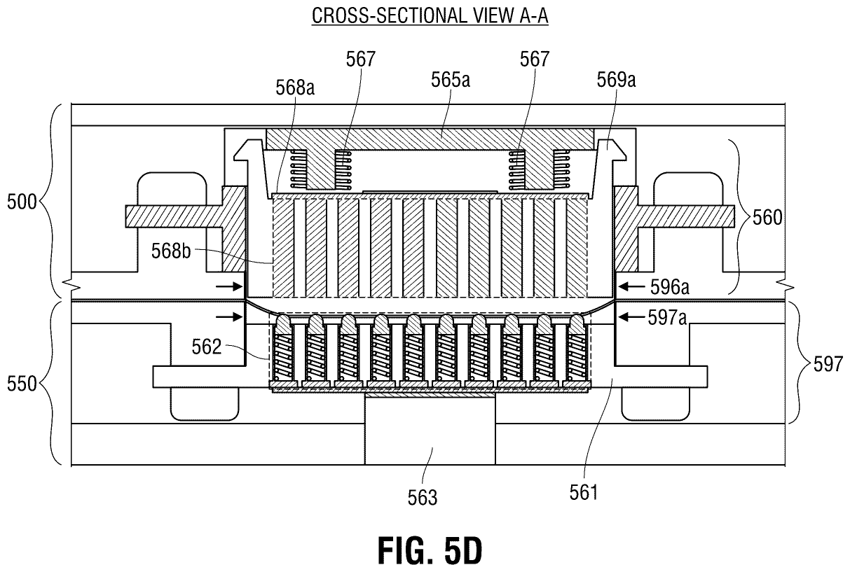

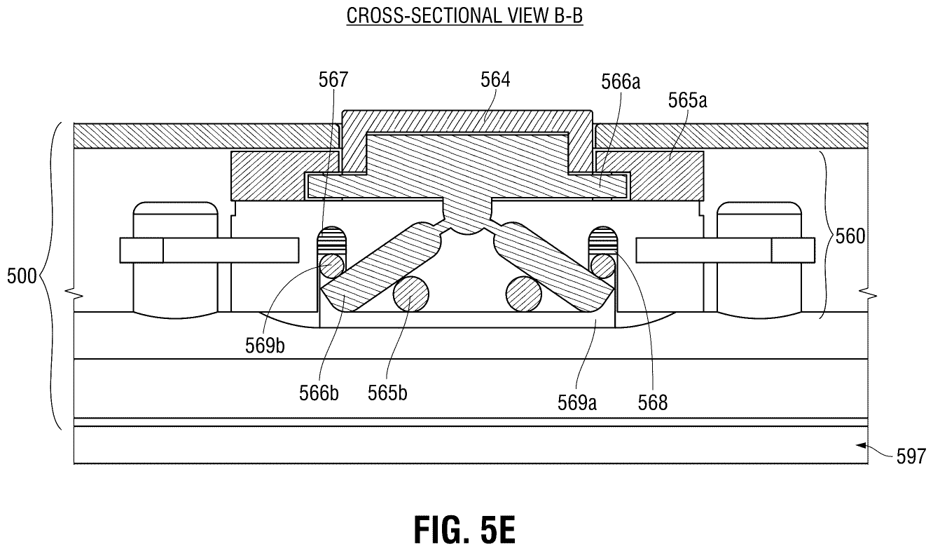

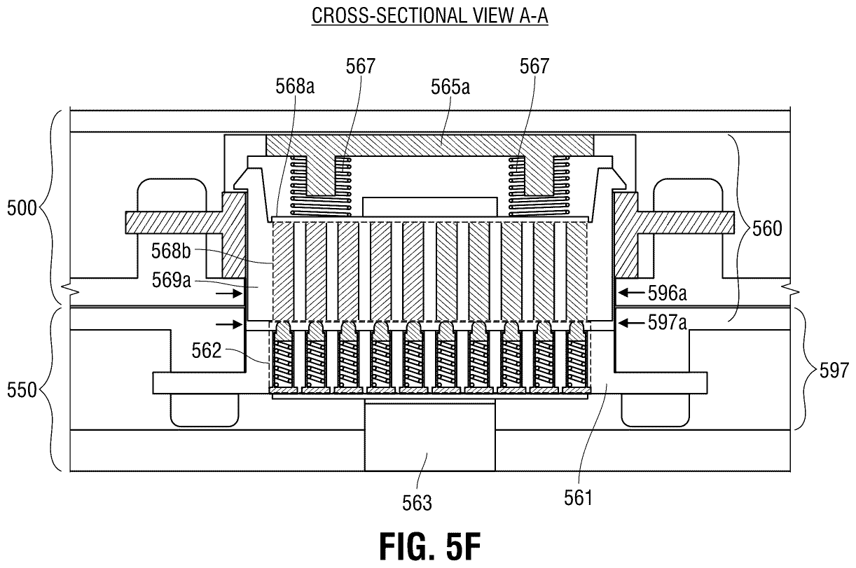

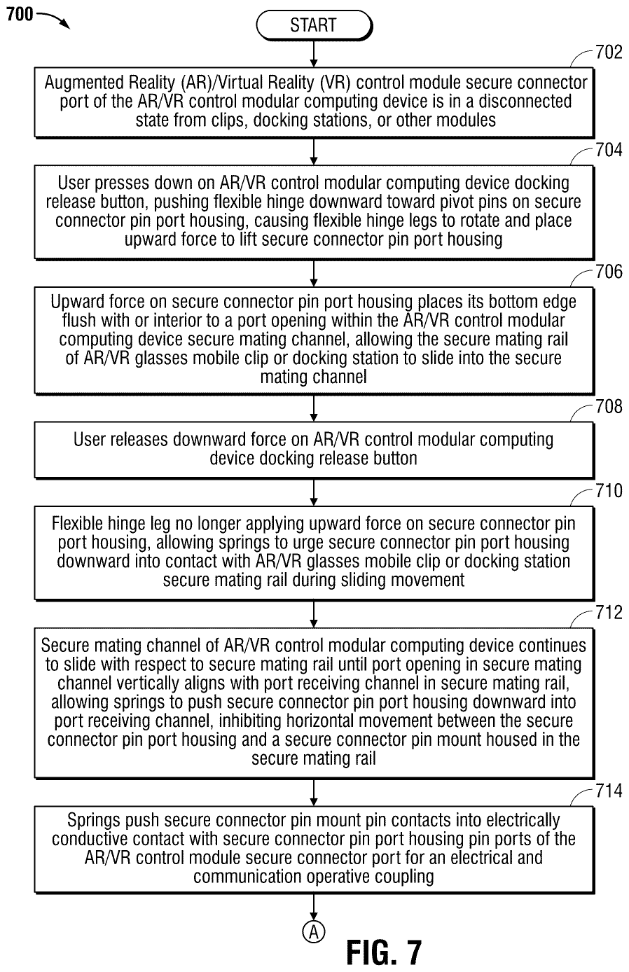

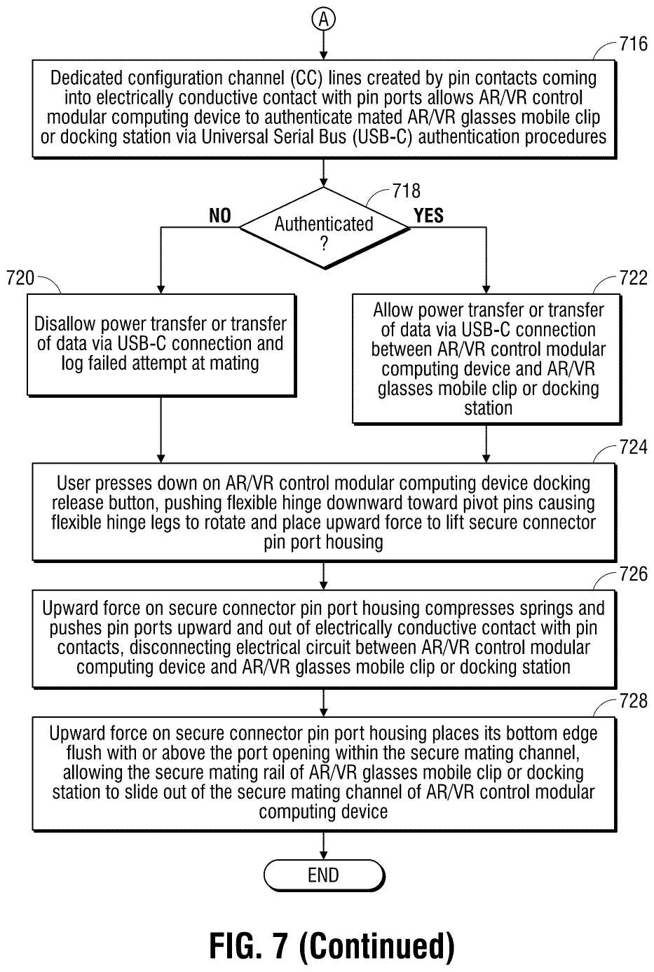

A secure connector port cable within the AR/VR control modular computing device secure connector port 160 may be operatively coupled with a bus 117 of the AR/VR control modular computing device 100 in an embodiment for the transfer of power and data between the AR/VR control modular computing device 100 and the AR/VR control modular computing device docking station 150 or AR/VR glasses mobile clip device 120 in various embodiments herein. As described in greater detail below with respect to FIGS. 5A, 5B, 5C, 5D, 5E, 5F, and 7 below, the AR/VR control modular computing device secure connector port 160 may be formed with a plurality of pin ports in a secure connector pin port housing movable into a secure mating channel. With the AR/VR control modular computing device secure connector port 160 engages, the plurality of pin ports in the secure connector pin port housing may engage with a plurality of pin contacts within a secure connector pin mount in a secure mating rail of either the AR/VR glasses mobile clip device 120 or the AR/VR control modular computing device docking station 150. This forms an electrically conductive contact for the pin ports within a secure connector pin port housing of the AR/VR control modular computing device 100 with either the AR/VR glasses mobile clip device 120 or the AR/VR control modular computing device docking station 150. Such an electrically conductive contact in an embodiment may complete a power or data transfer connection, such as a Universal Serial Bus (USB-C) connection, for example, between the AR/VR control modular computing device 100 and the AR/VR glasses mobile clip device 120 or AR/VR control modular computing device docking station 150.

Dedicated configuration channel (CC) lines created by at least a portion of these pin contacts coming into electrically conductive contact with at least a portion of the pin ports may allow the AR/VR control modular computing device 100 to authenticate the mated AR/VR glasses mobile clip device 120 or AR/VR control modular computing device docking station 150 or vice-versa, via USB-C standard or other proprietary authentication procedures. The AR/VR control modular computing device 150 in an embodiment may determine whether the mated AR/VR glasses mobile clip device 120 or mated AR/VR control modular computing device docking station 150 has been authenticated for operative coupling and use through execution of machine readable code instructions 114 of the AR/VR control modular computing device docking authentication system 116. The AR/VR control modular computing device 100 may only transfer power or data with the mated AR/VR glasses mobile clip device 120 or mated AR/VR control modular computing device docking station 150 in an embodiment if the AR/VR control modular computing device 100 successfully authenticates the mated AR/VR glasses mobile clip device 120 or mated AR/VR control modular computing device docking station 150. This authentication may be also required for operative coupling and operation of the AR/VR control modular computing device 100 to be authenticated with either of the mated AR/VR glasses mobile clip device 120 or mated AR/VR control modular computing device docking station 150 in other embodiments.

A wired data transfer connection 121 or 191 may be established between the AR/VR glasses 190 and the AR/VR glasses mobile clip device 120 or the AR/VR control modular computing device docking station 150, respectively, for the transfer of machine readable code instructions received from the AR/VR control modular computing device 100, via the data transfer connection 121 or 191, directing the display of generated AR/VR images at the display projector 111 of the AR/VR glasses 190. For example, the hardware processor 102 or graphical processing unit (GPU) 106 may execute machine readable code instructions of AR/VR glasses firmware 119 to generate and display AR or VR projected images, via a display projector 111 within the operatively coupled AR/VR glasses 190.

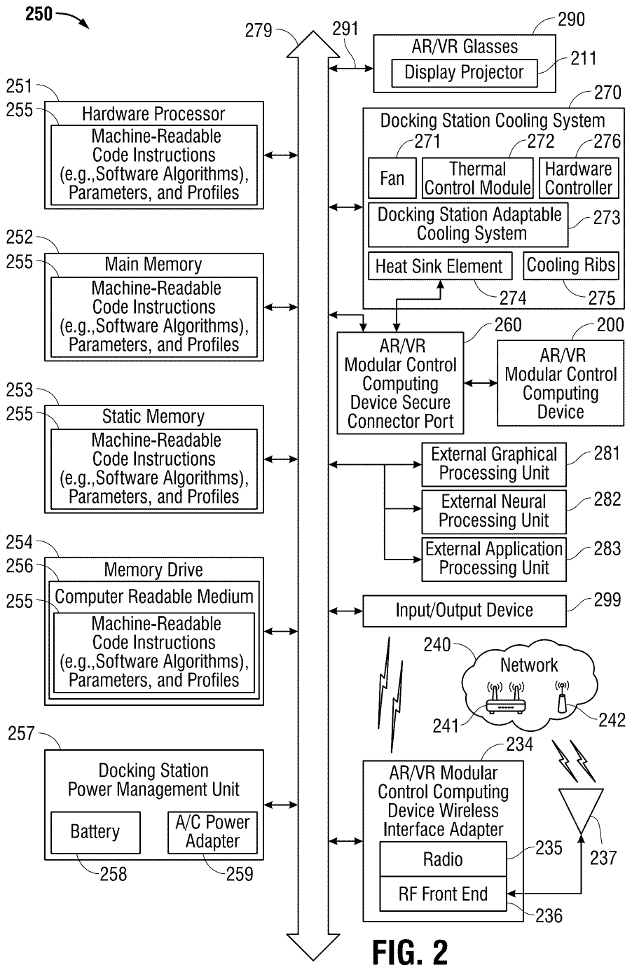

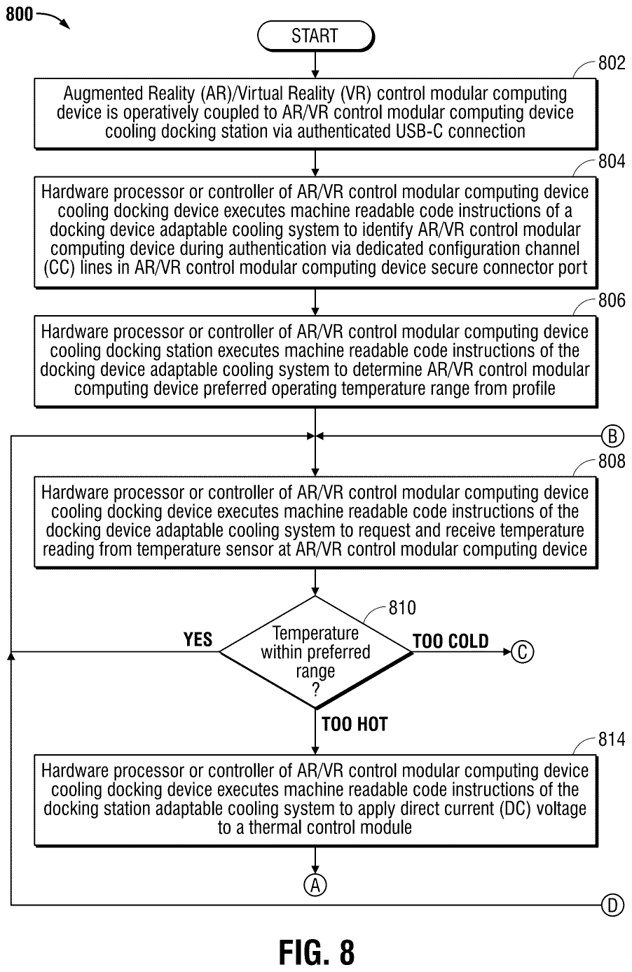

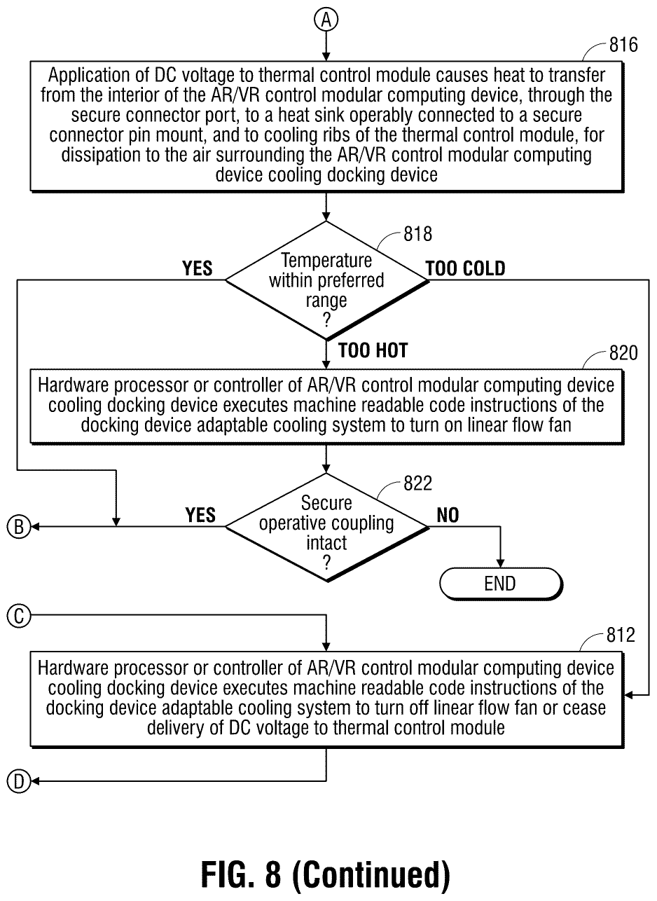

In some embodiments, the AR/VR control modular computing device docking station 150 may comprise an AR/VR control modular computing device cooling docking station that uses a thermal pathway formed by the AR/VR control modular computing device secure connector port 160 between a secure mating rail of the AR/VR control modular computing device cooling docking station 150 and a secure mating channel of the AR/VR control modular computing device 100 to dissipate heat from the AR/VR control modular computing device 100 and maximize its performance. The AR/VR control modular computing device cooling docking station 150 in such an embodiment may request and receive from the AR/VR control modular computing device 100, a temperature reading from a temperature sensor 118 at the AR/VR control modular computing device 100. Such a temperature sensor 118 in an embodiment may be used to routinely record internal operating temperatures of the AR/VR control modular computing device 100. These thermal readings may be transmitted to the AR/VR control modular computing device docking station 150 in an embodiment to allow a docking station cooling system within the AR/VR control modular computing device docking station 150 to cool the AR/VR control modular computing device 100 when operating temperatures exceed a preferred operating temperature range, in order to maximize performance of the AR/VR control modular computing device 100, as described in greater detail below with respect to FIGS. 2 and 8.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system operating as the AR/VR control modular computing device 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), a graphics processing unit (GPU) 106, other hardware controllers, or any combination thereof. Additional components of the information handling system operating as the AR/VR control modular computing device 100 may include one or more storage devices such as static memory 105 or drive unit 115. The information handling system operating as the AR/VR control modular computing device 100 may include or interface with one or more communications ports for communicating with external devices, as well as one or more input/output (IO) devices 199, a video/graphics digital display device, or any combination thereof. Portions of an information handling system 100 may themselves be considered information handling systems 100.

Information handling system operating as the AR/VR control modular computing device 100 may include devices or modules that embody one or more of the hardware devices or hardware processing resources executing machine readable code instructions for one or more systems and modules. The information handling system operating as the AR/VR control modular computing device 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems operating as the AR/VR control modular computing device 100.

The information handling system operating as the AR/VR control modular computing device 100 may include the hardware processor 102 such as a central processing unit (CPU) or other hardware processing resources on the AR/VR control modular computing device 100. Any of the hardware processing resources may operate to execute machine readable code instructions 114 that are either firmware or software code. The hardware processor 102 in the AR/VR control modular computing device 100 may comprise a vector CPU or multi-vector CPU or may be a graphics processing unit (GPU) 106 or other hardware processing resource.

Moreover, the information handling system operating as the AR/VR control modular computing device 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, GPU 106, or any other hardware processing device. The information handling system 100 may also include one or more buses 117 operable to transmit communications between the various hardware components such as any combination of various I/O devices 199, as well as between hardware processors 102, GPU 106 or other, the operating system (OS) 113, the basic input/output system (BIOS) 110, the wireless interface adapter 130, or a radio module 131, among other components described herein. In an embodiment, the hardware processor 102, and/or GPU 106 may execute one or more bus drivers in order to transmit this data between the information handling system operating as the AR/VR control modular computing device 100 and the input/output devices 199 described herein.

A network interface device 130 of the information handling system operating as the AR/VR control modular computing device 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 131, RF front end 132 and antenna 133 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system operating as the AR/VR control modular computing device 100, via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system operating as the AR/VR control modular computing device 100. Wireless interface adapter 130 may include one or more radio frequency (RF) subsystems (e.g., radio 131) with transmitter/receiver circuitry, modem circuitry, one or more antenna RF front end circuits 132, one or more wireless controller circuits, amplifiers, antennas 133, and other circuitry of the radio 131, such as one or more antenna ports used for wireless communications via multiple radio access technologies (RATs). The radio 131 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system operating as the AR/VR control modular computing device 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium 112 that includes machine-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130. The information handling system 100 may include a set of instructions 114, that may be executed to cause the AR/VR control modular computing device 100 to perform any one or more of the methods or computer-based functions disclosed herein. For example, machine readable code instructions 114 may be executed by a hardware processor 102, GPU 106, or any other hardware processing resource and may include software agents, or other aspects or components used to execute the methods and systems described herein. Various software modules or firmware modules comprising application machine readable code instructions 114 may be coordinated by an OS 113, and/or via an application programming interface (API) include a unified device API described herein. An example OS 113 may include Windows®, Android®, and other OS types. Example APIs may include Win 32, Core Java API, or Android APIs.

In an embodiment, the information handling system operating as the AR/VR control modular computing device 100 may include a disk drive unit 115. The disk drive unit 115 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, or GPU 106 of information handling system 100.

Main memory 103, or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system operating as the AR/VR control modular computing device 100 may further include a power management unit (PMU) 107 (a.k.a. a power supply unit (PSU)). The PMU 107 may include a hardware controller and executable machine-readable code instructions to manage the power provided to the components of the information handling system operating as the AR/VR control modular computing device 100 such as the hardware processor 102 and other hardware components described herein. The PMU 107 may control power to one or more components including the one or more drive units 115, the hardware processor 102 (e.g., CPU), the GPU 106, or other wired I/O devices 199 and other components that may require power when a power button has been actuated by a user. In an embodiment, the PMU 107 may monitor power levels and be electrically coupled to the information handling system operating as the AR/VR control modular computing device 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system operating as the AR/VR control modular computing device 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2 is a block diagram illustrating an augmented reality/virtual reality (AR/VR) control modular computing device docking station executing machine readable code instructions of an docking station adaptable cooling system according to an embodiment of the present disclosure. As described herein, the AR/VR glasses 290 in an embodiment may be operatively coupled to the AR/VR control modular computing device docking station 250, via a data and power transfer cord 291 (e.g., Universal Serial Bus (USB)-C cord). The AR/VR control modular computing device docking station 250 in an embodiment may further be operatively coupled to the AR/VR control modular computing device 200 via an AR/VR control modular computing device secure connector port 260 engaged through slidable attachment and detachment of a secure mating channel and reciprocal secure mating rail between the AR/VR control modular computing device docking station 250 and the AR/VR control modular computing device 200. The AR/VR control modular computing device docking station 250 in an embodiment may be wired or wirelessly connected to one or more external input/output (I/O) devices 299.

The AR/VR control modular computing device docking station 250 in an embodiment may include a hardware processor 251 for execution of machine readable code instructions 255 for software applications and the like in support of an operatively coupled AR/VR control modular computing device 200 in an embodiment. The AR/VR control modular computing device docking station 250 may include augmented hardware processing resources onboard as hardware processor 251 that may be additional graphics processing unit (GPU), neural processing unit (NPU), or application processing unit (APU) in an embodiment. The AR/VR control modular computing device docking station 250 in an embodiment may also be operatively coupled, via communication ports such as Universal Serial Bus (USB) ports (e.g., USB 3.0, USB-C), to one or more external input/output devices 299 or one or more external augmented hardware processor devices, such as a graphics processing unit (GPU) 281, neural processing unit (NPU) 282, or application processing unit (APU) 283, for example in other embodiments. This may allow the AR/VR control modular computing device 200 in an embodiment to leverage additional processing power of onboard hardware processor 251 or these external augmented hardware processor devices 281, 282, or 283 to maximize performance of the AR/VR glasses 290 when in use.

The AR/VR control modular computing device 200 in an embodiment may draw power via engagement of the AR/VR control modular computing device secure connector port 260 formed by mating with the AR/VR control modular computing device docking station 250. The docking station battery 258 or docking station A/C power adapter 259 may provide power via the AR/VR control modular computing device secure connector port 260. The AR/VR glasses 290 in an embodiment may be powered directly via the USB-C cord 291 from the AR/VR control modular computing device docking station 250 as well. A secure connector pin mount cable within the AR/VR control modular computing device docking station 250, as described in greater detail below with respect to FIGS. 5A, 5B, 5C, 5D, 5E, and 5F, may be operatively coupled via electrically conductive contact with secure connector pin connectors within the AR/VR control modular computing device secure connector port 260 to a bus of the AR/VR control modular computing device docking station 279 in an embodiment. This electrical coupling via secure connector pin ports in the AR/VR control modular computing device secure connector port 260 and pin contacts in the reciprocal secure connector pin mount may provide for transfer of power and data between the AR/VR control modular computing device 200 and the AR/VR control modular computing device docking station 250.

In some embodiments, the AR/VR control modular computing device docking station 250 may comprise an AR/VR control modular computing device cooling docking station that uses a thermal pathway formed by the secure connector pin mount and the reciprocal AR/VR control modular computing device secure connector port 260 operatively coupled between a secure mating rail of the AR/VR control modular computing device cooling docking station 250 and a secure mating channel of the AR/VR control modular computing device 200 to dissipate heat from the AR/VR control modular computing device 200 and maximize its performance. Upon mating of the secure mating rail of the AR/VR control modular computing device cooling docking station 250 and the secure mating channel of the AR/VR control modular computing device 200 to establish a secure power and data transfer connection, such as described below with respect to FIG. 7, a hardware processor 251 or hardware controller 276 of the AR/VR control modular computing device cooling docking station 250 may execute machine readable code instructions 255 of a docking station adaptable cooling system 270. Execution of the docking station adaptable cooling system 270 operates a thermal control module 272 or cooling fans 271 within the AR/VR control modular computing device cooling docking station 250 facilitate cooling of heat transferred from the thermal pathway to enhance cooling of the AR/VR control modular computing device 200.

In an embodiment, and as described in greater detail below with respect to FIG. 7, the AR/VR control modular computing device 200 may be securely and operatively coupled to an AR/VR control modular computing device cooling docking station 250, via an authenticated data transfer connection formed through the AR/VR control modular computing device secure connector port 260, such as Universal Serial Bus (USB) C. As described in greater detail below, the physical mechanism of the AR/VR control modular computing device secure connector port 260 engaged with the secure connector pin mount by which such a secure data transfer connection may formed also forms a thermal pathway as well as an air transfer pathway in some embodiments. This operative and thermal coupling between the AR/VR control modular computing device secure connector port 260 engaged with the secure connector pin mount is a thermal pathway through which heat may be transferred between the AR/VR control modular computing device 200 and the AR/VR control modular computing device cooling docking station 250 for dissipation of heat by its docking station cooling system 270.

A hardware processor 251 or hardware controller 276 of the AR/VR control modular computing device cooling docking station 250 in an embodiment may execute machine readable code instructions 255 of the docking station adaptable cooling system 273 to identify the AR/VR control modular computing device 200 for authentication and access, via dedicated configuration channel (CC) lines in the AR/VR control modular computing device secure connector port 260 and secure connector pin mount junction. Such an identification may include transmission of an external device identifier (EDID) or of a media access control (MAC) address, for example.

The hardware processor 251 or hardware controller 276 of AR/VR control modular computing device cooling docking station 250 may also execute machine readable code instructions 255 of the docking station adaptable cooling system 273 to determine an AR/VR control modular computing device 200 preferred operating temperature range, as stored in a profile for the identified and authenticated AR/VR control modular computing device 200. Such a profile may be stored, for example, within main memory 252, static memory 253, or memory drive 254 at the AR/VR control modular computing device cooling docking station 250. In other embodiments, the profile may be transferred from the operatively coupled AR/VR control modular computing device 200 to the AR/VR control modular computing device cooling docking station 250. For example, one or more thermal operation profiles may be stored within machine-readable code instructions or profiles 255 in main memory 252, static memory 253, or memory drive 254 in various embodiments herein. Each of such profiles may be associated with or received from a separately identified and authenticated AR/VR control modular computing device 200 in various embodiments herein. Each of such profiles may provide a range of operating temperatures, such as between X and Y degrees Fahrenheit, in which the AR/VR control modular computing device 200 associated with that profile best operates.

The hardware processor 251 or hardware controller 276 of the AR/VR control modular computing device cooling docking station 250 in an embodiment may execute machine readable code instructions 255 of the docking station adaptable cooling system 273 to request and receive from the AR/VR control modular computing device 200, a temperature reading from a temperature sensor at the AR/VR control modular computing device 200. The hardware processor 251 or hardware controller 276 of AR/VR control modular computing device cooling docking station 250 in an embodiment may execute machine readable code instructions 255 of the docking station adaptable cooling system 273 to determine whether the received temperature reading is within the preferred operating temperature range for the identified and authenticated AR/VR control modular computing device 200. Operation of the AR/VR control modular computing device 200 outside of the preferred temperature range described herein may result in poor user satisfaction, for example, due to slow processing times or operating errors.

In an embodiment in which the received temperature reading is outside the preferred operating temperature range for the AR/VR control modular computing device 200, and is cooler than the preferred operating temperature range, the hardware processor 251 or hardware controller 276 of the AR/VR control modular computing device cooling docking station 250 may execute machine readable code instructions 255 of the docking station adaptable cooling system 273 to turn off a linear flow fan 271 or cease delivery of DC voltage to a thermal control module 272 within the docking station cooling system 270. Such a fan 271 and a thermal control module 272 are part of the docking station cooling system 270 used receive and dissipate heat via the thermal pathway with the AR/VR control modular computing device 200, as described directly below. Thus, when the operating temperatures falls below the preferred range, this may indicate that currently engaged fans 271 or thermal control module 272 of the docking station cooling system 270 no longer need be active. The thermal control module 272 along with heat sink elements 274, heat pipes, and cooling ribs 275 of the docking station cooling system 270 that may operate to provide the thermal pathway to draw heat away from and cool the AR/VR control modular computing device 200. The linear flow fan 271 of the docking station cooling system 270 may operate to accelerate dissipation of heat within the AR/VR control modular computing device cooling docking station 250 in other embodiments.

In an embodiment in which the received temperature reading is outside the preferred operating temperature range for the AR/VR control modular computing device 200, and is hotter than the preferred operating temperature range, the hardware processor 251 or hardware controller 276 of the AR/VR control modular computing device cooling docking station 250 may execute machine readable code instructions 255 of the docking station adaptable cooling system 273 to apply direct current (DC) voltage to a thermal control module 272. The thermal control module 272 of the docking station cooling system 270 may comprise, for example, a Peltier thermoelectric module, or a magnetocaloric material in various embodiments.

A magnetocaloric material in an example embodiment of a thermal control module 272 may increase or decrease in temperature when a DC voltage is applied to alter the magnetic field of the material. Reorientation of magnetic domains during this process may cause the absorption or release of thermal energy via a magnetocaloric cooling effect.

A Peltier thermoelectric module as an embodiment of a thermal control module 272 may comprise two semiconductor elements operatively coupled to a single metal plate on one side (e.g., top), with each of the semiconductor elements also operatively coupled to separate metal plates on the other side (e.g., bottom). Each semiconductor may direct thermal energy in one direction (e.g., either from the top to the bottom or from the bottom to the top), upon application of a DC voltage to the semiconductor. Thus, application of DC voltage to a specific semiconductor element within the Peltier thermoelectric module may cause thermal energy to increase in one direction. For example, the thermal control module 272 as a Peltier thermoelectric module may cause thermal energy to increase in one direction toward a heat sink element 274 within the AR/VR control modular computing device cooling docking station 250. This directional thermal energy draw may draw thermal energy away from the AR/VR control modular computing device secure connector port 260 and to an operatively coupled heatsink element 274 thereby cooling the AR/VR control modular computing device 200. The heat sink element 274 in an embodiment may further be operatively and thermally coupled to the cooling ribs 275 having external surfaces on the exterior housing of the AR/VR control modular computing device docking station 250 or subject to airflow from the linear cooling fan 271. Heat may thus be transferred from the heatsink element 274, to the cooling ribs 275, and dissipated outward through contact with the air surrounding the AR/VR control modular computing device docking station 250 in an embodiment.

Following engagement of the thermal control module 272 to cool the AR/VR control modular computing device 200, the hardware processor 251 or controller 276 of the AR/VR control modular computing device cooling docking station 250 in an embodiment may execute machine readable code instructions 255 of the docking station adaptable cooling system 273 to again determine whether the received temperature reading is within the preferred operating temperature range for the identified and authenticated AR/VR control modular computing device 200. In an embodiment in which the received temperature reading is still outside the preferred operating temperature range for the AR/VR control modular computing device 200, and is still hotter than the preferred operating temperature range, the hardware processor 251 or hardware controller 276 of the AR/VR control modular computing device cooling docking station 250 may execute machine readable code instructions 255 of the docking station adaptable cooling system 273 to turn on a linear flow fan 271. The linear flow fan 271 of the docking station cooling system 270 may, for example, blow air across the cooling ribs 275 within or outside the AR/VR control modular computing device docking station housing to further cool the AR/VR control modular computing device 200 or may merely cool the interior of the AR/VR control modular computing device docking station housing.

The information handling system operating as the AR/VR control modular computing device docking station 250 may include main memory 252, (volatile (e.g., random-access memory, etc.), or static memory 253, nonvolatile (read-only memory, flash memory etc.) or any combination thereof), one or more hardware processing resources, such as a hardware processor 251 that may be a central processing unit (CPU), a graphics processing unit (GPU), other hardware controllers, or any combination thereof, that may augment hardware processing resources for the AR/VR control modular computing device 200. Additional components of the information handling system operating as the AR/VR control modular computing device docking station 250 may include one or more storage devices such as static memory 253 or drive unit 254. The information handling system operating as the AR/VR control modular computing device docking station 250 may include or interface with one or more communications ports for communicating with external devices, as well as one or more input/output (IO) devices 299, a video/graphics digital display device, or any combination thereof.

Information handling system operating as the AR/VR control modular computing device docking station 250 may include devices or modules that embody one or more of the hardware devices or hardware processing resources executing machine readable code instructions for one or more systems and modules. The AR/VR control modular computing device docking station 250 may execute machine readable code instructions (e.g., software or firmware algorithms), parameters, and profiles 255 of the docking station adaptable cooling system or other software or firmware applications as with an information handling system that may utilize the AR/VR glasses 290 or any I/O devices 299 when executed by the user. Any of the hardware processing resources, such as hardware processor 251 or hardware controller 276, may operate to execute machine readable code instructions 255 that are either firmware or software code. The hardware processor 251 in the AR/VR control modular computing device docking station 250 may comprise a vector CPU or multi-vector CPU or may be a graphics processing unit (GPU) or other hardware processing resource and may execute software or firmware in conjunction with the operably coupled AR/VR control modular computing device 200 in embodiments herein.

Moreover, the information handling system operating as the AR/VR control modular computing device docking station 250 may include memory such as main memory 252, static memory 253, and disk drive unit 254 (volatile (e.g., random-access memory, etc.), nonvolatile memory (read-only memory, flash memory etc.) or any combination thereof or other memory with computer readable medium 256 storing machine readable code instructions (e.g., software or firmware algorithms), parameters, and profiles 255 executable by the hardware processor 251, or any other hardware processing device. The information handling system operating as the AR/VR control modular computing device docking station 250 may also include one or more buses 279 operable to transmit communications between the various hardware components such as any combination of various I/O devices 299, as well as between hardware processors 251 or other, the wireless interface adapter 234, or a radio module 235, among other components described herein. In an embodiment, the hardware processor 251 may execute one or more bus drivers in order to transmit this data between the information handling system operating as the AR/VR control modular computing device docking station 250 and the input/output devices 299 described herein.

A network interface device 234 of the information handling system operating as the AR/VR control modular computing device docking station 250 may be wired or wireless such as shown with wireless interface adapter 234 that can provide wireless connectivity among devices or to a network 240, e.g., a wide area network (WAN), a local area network (LAN), wireless local area network (WLAN), a wireless personal area network (WPAN), a wireless wide area network (WWAN), or other network via any wireless protocol. In embodiments described herein, the wireless interface device 234 with its radio 235, RF front end 236 and antenna 237 is used to communicate with the network 240, via, for example, a Bluetooth® or Bluetooth® Low Energy (BLE) protocols, or other WPAN or WLAN protocols.

In an embodiment, a WAN, WWAN, LAN, and WLAN may each include an AP 241 or base station 242 used to operatively couple the information handling system operating as the AR/VR control modular computing device docking station 250, via a wireless interface adapter 234. Wireless interface adapter 234 may include one or more radio frequency (RF) subsystems (e.g., radio 235) with transmitter/receiver circuitry, modem circuitry, one or more antenna RF front end circuits 236, one or more wireless controller circuits, amplifiers, antennas 237, and other circuitry of the radio 235, such as one or more antenna ports used for wireless communications via multiple radio access technologies (RATs). The radio 235 may communicate with one or more wireless technology protocols.

In an embodiment, the wireless interface adapter 234 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 234 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 234 can represent an add-in card, wireless network interface module that is integrated with a main board of the information handling system operating as the AR/VR control modular computing device docking station 250 or integrated with another wireless network interface capability, or any combination thereof.

The present disclosure contemplates a computer-readable medium 256 that includes machine-readable code instructions, parameters, and profiles 255 or receives and executes instructions, parameters, and profiles 255 responsive to a propagated signal, so that a hardware device connected to a network 240 may communicate voice, video, or data over the network 240. Further, the machine readable code instructions 255 may be transmitted or received over the network 240 via the network interface device or wireless interface adapter 234. The information handling system operating as the AR/VR control modular computing device docking station 250 may include a set of instructions 255, that may be executed to cause the AR/VR control modular computing device docking station 250 to perform any one or more of the methods or computer-based functions disclosed herein. For example, machine readable code instructions 255 may be executed by a hardware processor 251, or any other hardware processing resource and may include software agents, or other aspects or components used to execute the methods and systems described herein.

In an embodiment, the information handling system operating as the AR/VR control modular computing device docking station 250 may include a disk drive unit 254. The disk drive unit 254 may include machine-readable code instructions, parameters, and profiles 255 in which one or more sets of machine-readable code instructions, parameters, and profiles 255 such as firmware or software can be embedded to be executed by the hardware processor 251 or other hardware processing devices, or other microcontroller units 276 to perform the processes described herein. Similarly, main memory 252 and static memory 253 may also contain a computer-readable medium for storage of one or more sets of machine-readable code instructions, parameters, or profiles 255 described herein. The disk drive unit 254 or static memory 253 also contain space for data storage. Further, the machine-readable code instructions, parameters, and profiles 255 may embody one or more of the methods as described herein. In a particular embodiment, the machine-readable code instructions, parameters, and profiles 255 may reside completely, or at least partially, within the main memory 252, the static memory 253, and/or within the disk drive 254 during execution by the hardware processor 251 of information handling system operating as the AR/VR control modular computing device docking station 250.

Main memory 252, or other memory of the embodiments described herein may contain computer-readable medium (not shown), such as RAM in an example embodiment. An example of main memory 252 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 253 or on the disk drive unit 254 that may include access to a machine-readable code instructions, parameters, and profiles 255 such as a magnetic disk or flash memory in an example embodiment.

In an embodiment, the information handling system operating as the AR/VR control modular computing device docking station 250 may further include a power management unit (PMU) 257 (a.k.a. a power supply unit (PSU)). The PMU 257 may include a hardware controller and executable machine-readable code instructions to manage the power provided to the components of the information handling system operating as the AR/VR control modular computing device docking station 250 such as the hardware processor 251 and other hardware components described herein. The PMU 257 may control power to one or more components including the one or more drive units 254, the hardware processor 251 or other wired I/O devices 299 and other components that may require power when a power button has been actuated by a user. In an embodiment, the PMU 257 may monitor power levels and be electrically coupled to the information handling system operating as the AR/VR control modular computing device docking station 250 to provide this power. The PMU 257 may be coupled to the bus 279 to provide or receive data or machine-readable code instructions. The PMU 257 may regulate power from a power source such as the battery 258 or AC power adapter 259. In an embodiment, the battery 258 may be charged via the AC power adapter 259 and provide power to the components of the information handling system operating as the AR/VR control modular computing device docking station 250, via wired connections as applicable, or when AC power from the AC power adapter 259 is removed.

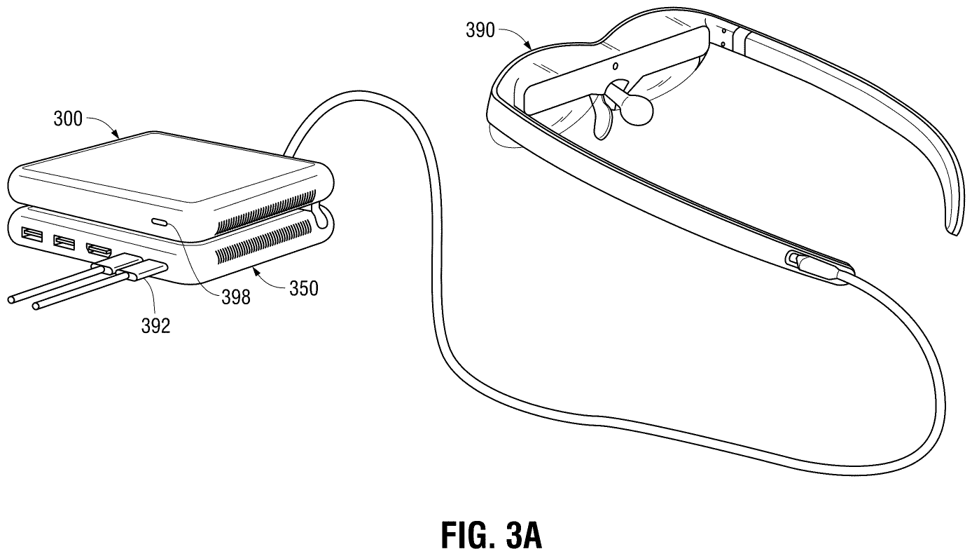

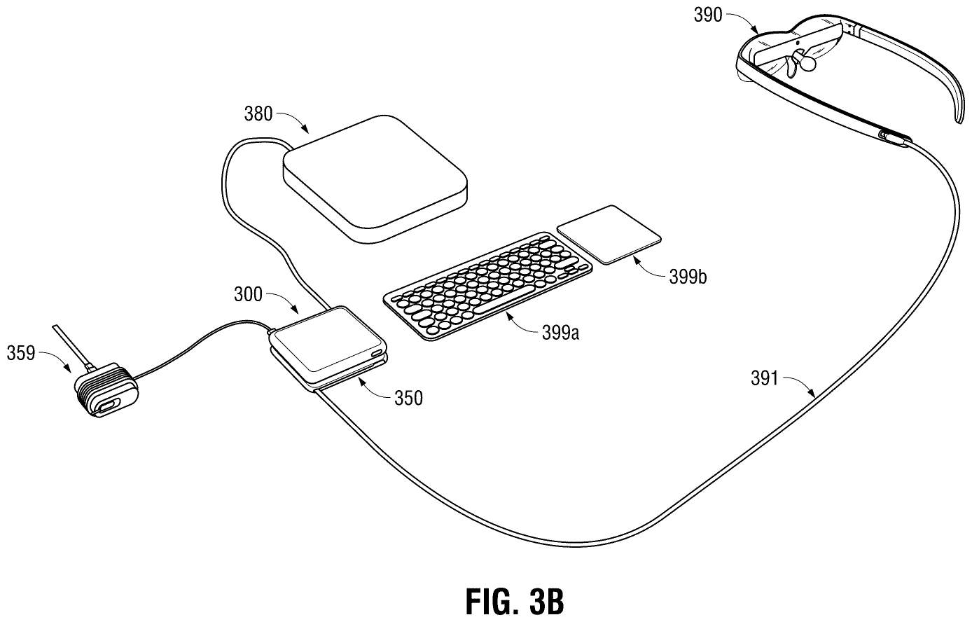

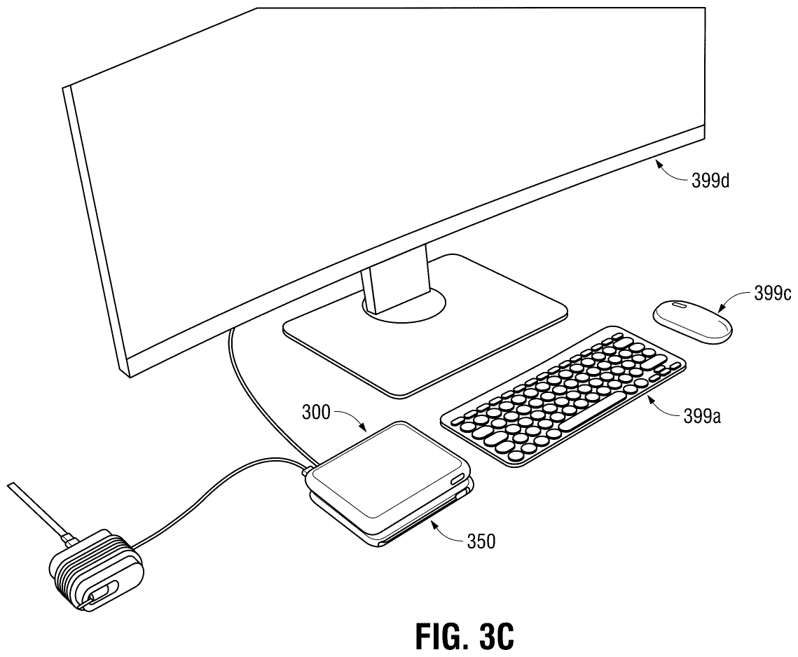

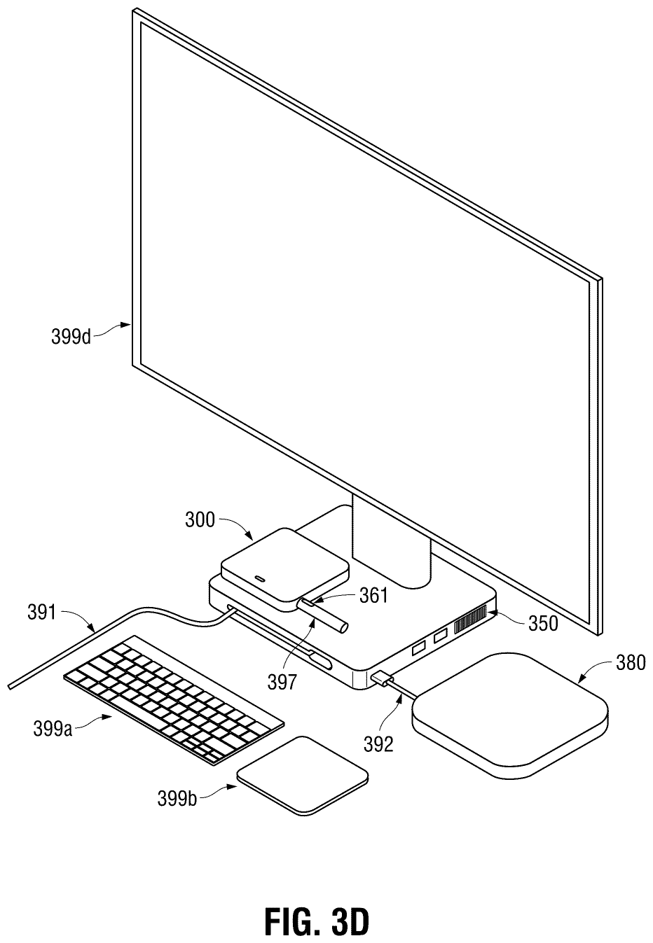

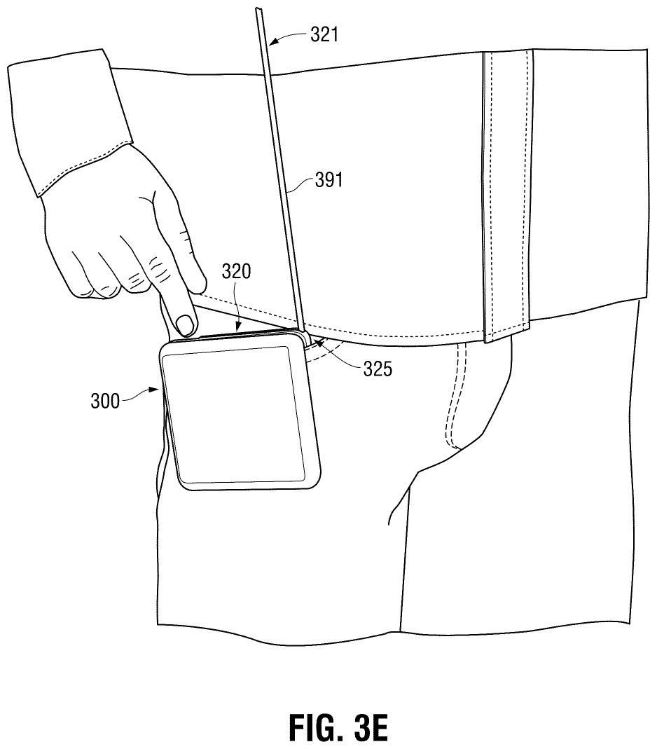

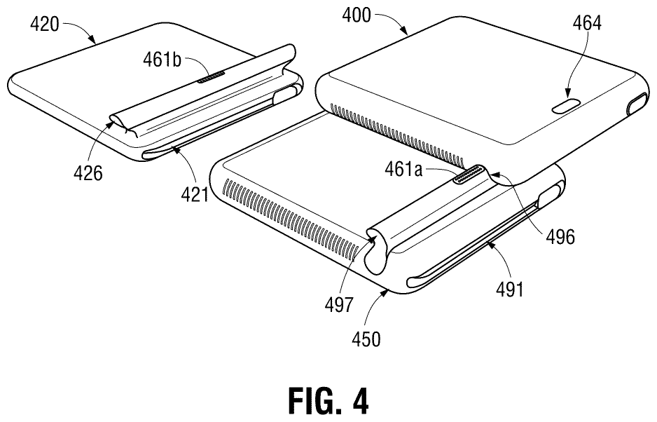

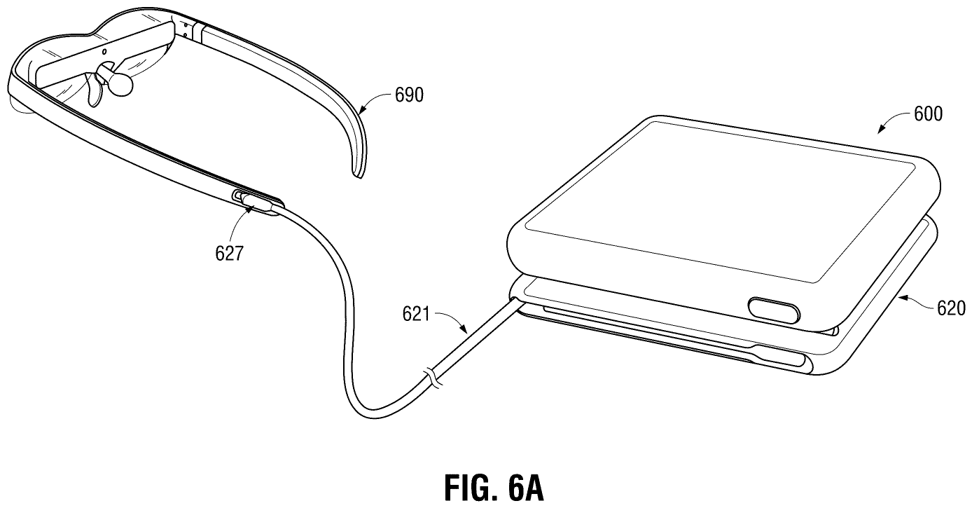

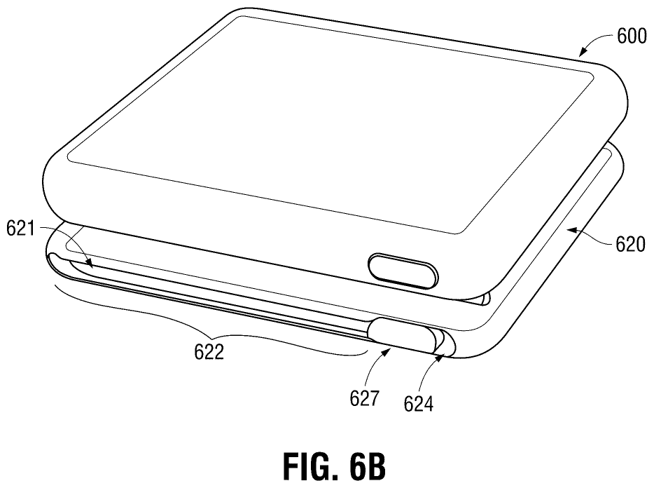

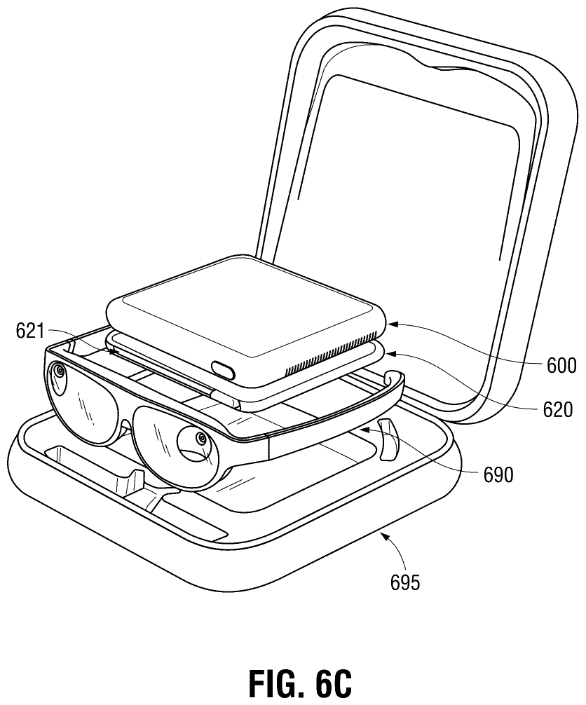

FIG. 3A is a graphical diagram illustrating an augmented reality/virtual reality (AR/VR) control modular computing device docking station 350 operably coupled to AR/VR glasses and to an AR/VR control modular computing device for control of the AR/VR glasses by the AR/VR control modular computing device through the AR/VR control modular computing device docking station according to an embodiment of the present disclosure. An ecosystem of devices are described herein, which include AR/VR glasses 390, an AR/VR glasses mobile clip device for mobile use of the AR/VR glasses (e.g., as described below with respect to FIGS. 4, 6A, 6B, and 6C), and an AR/VR control modular computing device 300. The AR/VR control modular computing device 300 is multifunctional in that it operates to generate and orchestrate the display of digital content within the AR/VR glasses 390 as well as for operating other computing functions for a user with I/O devices in a physical desktop space such as a standalone digital display device, keyboard, mouse, dial or other I/O peripheral device for execution of machine readable code instructions of software or firmware in embodiments herein. The AR/VR control modular computing device 300 may operatively couple with either the AR/VR glasses mobile clip device (not shown) for mobile use, or with an AR/VR control modular computing device docking station 350 for stationary or desktop use via an AR/VR control modular computing device secure connection port between a reciprocal secure mating channel on one side and a secure mating rail on the other side.

The AR/VR glasses 390 in an embodiment may be operatively coupled to the AR/VR control modular computing device docking station 350, via a data and power transfer cord (e.g., Universal Serial Bus (USB)-C cord). According to embodiments herein, the AR/VR control modular computing device docking station may further be operatively coupled to the AR/VR control modular computing device via a AR/VR control modular computing device secure connection port engaged through slidable attachment and detachment within a reciprocal secure mating channel and a secure mating rail of the AR/VR control modular computing device docking station 350 with the AR/VR control modular computing device 300. The AR/VR control modular computing device docking station 350 in an embodiment may also include augmented hardware processing resources such as a graphics processing unit (GPU), neural processing unit (NPU), or application processing unit (APU), in an example embodiment. The AR/VR control modular computing device docking station 350 in an embodiment may also be operatively coupled, via communication ports such as USB ports 392 (e.g., USB 3.0, USB-C), to one or more external input/output devices or one or more external augmented hardware processor devices, such as a graphics processing unit (GPU), neural processing unit (NPU), or application processing unit (APU), for example. This may allow the AR/VR control modular computing device 300 in an embodiment to leverage additional processing power of the AR/VR control modular computing device docking station 350 or of these external augmented hardware processor devices to maximize performance of the AR/VR glasses 390 when in use. The AR/VR control modular computing device 300 in an embodiment may draw power via the AR/VR control modular computing device secure connector port engaged by mating with the AR/VR control modular computing device docking station 350, or further by application of DC voltage via the direct power port 398. The AR/VR glasses 390 in an embodiment may be powered directly via the USB-C cord 391 from the AR/VR control modular computing device docking station 350 or from the AR/VR glasses mobile clip device described below with respect to FIGS. 4, 6A, 6A, and 6C.

FIG. 3B is a graphical diagram illustrating an augmented reality/virtual reality (AR/VR) control modular computing device docking station operably connected to AR/VR glasses and to an AR/VR control modular computing device for control of the AR/VR glasses with external augmented hardware processor devices operably connected to the AR/VR control modular computing device docking station according to an embodiment of the present disclosure. As described herein, using AR/VR glasses allows users to organize a virtual workspace in the space around themselves, projected on top of the real world, which may include other peripheral devices. Interactions in this physical workspace may use familiar peripherals such as a keyboard 399a, touchpad 399b, a mouse, a dial or other wired or wireless peripheral I/O devices for easy adoption and supporting existing applications executing on the AR/VR control modular computing device 300 and with support of the AR/VR control modular computing device docking station 350. The AR/VR control modular computing device docking station 350 in an embodiment may be wirelessly connected to one or more external input/output devices, such as wireless keyboard 399a and wireless touchpad 399b, for example, in an embodiment. This may allow the user to interact with these wireless input/output devices 399a and 399b to, for example, input keyboard strokes that may appear as text displayed within the AR/VR glasses 390 display or on a standalone digital display device (not shown). The touchpad 399b, for example, may allow the user to move a cursor within the AR/VR glasses 390 display as well as on any available standalone digital display that may be present in an embodiment.

The AR/VR control modular computing device docking station 350 in an embodiment may also be operatively coupled, via communication ports such as USB ports (e.g., 392 of FIG. 3A), to one or more external augmented hardware processor devices 380, which may include a graphics processing unit (GPU), neural processing unit (NPU), or application processing unit (APU), for example, to augment available hardware processing resources. This may allow the AR/VR control modular computing device 300 in an embodiment to leverage additional processing power of these external augmented hardware processor devices 380 to maximize performance of the AR/VR glasses 390 when in use. The AR/VR control modular computing device docking station 350 in an embodiment may draw power via the AC power adapter 350, which may be plugged into a wall outlet, for example.

FIG. 3C is a graphical diagram illustrating an augmented reality/virtual reality (AR/VR) control modular computing device docking station operably connected to AR/VR glasses and to an AR/VR control modular computing device for control of the AR/VR glasses and one or more input/output devices operably connected to the AR/VR control modular computing device docking station according to an embodiment of the present disclosure. As described herein, using AR/VR glasses (not shown) allows users to organize a virtual workspace in the space around themselves, projected on top of the real world, which may include other peripheral devices. Interactions in this physical workspace use familiar peripherals such as a digital display device 399d, keyboard 399a, or a mouse 399c, for easy adoption and supporting existing software or firmware applications executing on the AR/VR control modular computing device 300 and with support of the AR/VR control modular computing device docking station 350. The AR/VR control modular computing device docking station 350 in an embodiment may be operatively coupled, wirelessly or via communication ports such as USB ports (e.g., 392 of FIG. 3A), to one or more external input/output devices, such as digital display device 399d, keyboard 399b, or mouse 399c, for example, in an embodiment. This may allow the user to interact with these wired input/output devices 399c, 399a, and 399d to, for example, view augmented reality interactive icons surrounding the traditional display of content via the digital display 399d. The mouse 399c, for example, may allow the user to move a cursor within the AR/VR glasses 390 display, or within the digital display device 399d content in an embodiment. Keyboard 399a may provide input yielding characters displayed via the digital display device 399d or AR/VR glasses.

FIG. 3D is a graphical diagram illustrating an augmented reality/virtual reality (AR/VR) control modular computing device 300 operably coupled to an AR/VR control modular computing device cooling docking station 350 with integrated digital display device 399d and AR/VR glasses according to another embodiment of the present disclosure. The AR/VR control modular computing device cooling docking station 350 may include the integrated digital display device 399d as well as augmented hardware processing resources to support the AR/VR control modular computing device 300. Further, the AR/VR control modular computing device cooling docking station 350 may include a docking station cooling system for assisting to cool the operatively coupled AR/VR control modular computing device 300 during control by the AR/VR control modular computing device 300 of the AR/VR glasses and external I/O peripheral devices 399a, 399b, 399d operably coupled to the AR/VR control modular computing device docking station 350 according to an embodiment of the present disclosure. As described herein, the AR/VR control modular computing device cooling docking station 350 in an embodiment may comprise docking station cooling system that uses the thermal pathway formed through AR/VR control modular computing device secure connector port and the secure connector pin mount 361 between the AR/VR control modular computing device 300 and the AR/VR control modular computing device cooling docking station 350 to dissipate heat from the AR/VR control modular computing device 350 and maximize its performance.

Upon mating of a secure mating rail 397 of the AR/VR control modular computing device cooling docking station 350 and a secure mating channel formed into the housing of the AR/VR control modular computing device 300 to establish a secure power and data transfer connection, according to embodiments herein, a hardware processor or controller of the AR/VR control modular computing device cooling docking station 350 may execute machine readable code instructions of a docking station adaptable cooling system. The execution of the docking station adaptable cooling system operate a thermal control module or fans within the AR/VR control modular computing device cooling docking station 350 to cool the thermally coupled AR/VR control modular computing device 300. The physical mechanism by which such a secure data transfer connection 361 is formed, as described in greater detail in embodiments herein, may form a thermal pathway through which heat may be transferred between the AR/VR control modular computing device 300 and the AR/VR control modular computing device cooling docking station 350.

As also described herein, the AR/VR control modular computing device docking station 350 in an embodiment may also be operatively coupled, via communication ports such as USB port 392, to one or more external augmented hardware processor devices 380 which may include additional hardware processing resources such as a graphics processing unit (GPU), neural processing unit (NPU), or application processing unit (APU), for example, to assist with execution of software or firmware applications that may include AR/VR components. This may allow the AR/VR control modular computing device 300 in an embodiment to leverage additional processing power of these external augmented hardware processor devices 380 to maximize performance of the AR/VR glasses when in use.

FIG. 3E is a graphical diagram illustrating an augmented reality/virtual reality (AR/VR) glasses mobile clip operably coupled to AR/VR glasses via a cord and to an AR/VR control modular computing device for secure carrying of the AR/VR control modular computing device during mobile use of the AR/VR glasses according to an embodiment of the present disclosure. As computing processing capabilities grow, so too does a need for more room to display content for user interaction, such as across a plurality of digital display devices, for example. Another solution to such a need is to combine digital display devices with augmented reality or virtual reality (AR/VR) glasses that can further display holographic projected images of digital content, either in combination with, or in place of digital display devices such as digital display devices (e.g., 399d). Simultaneously, changes in working environments require that users be flexible to work in different locales, such as within the office, the home, public spaces, or on the move. Users desire the same computing experience and level of privacy that they enjoy in more controlled environments, such as their home or their office, across each of these potential working locales. Use of AR/VR glasses can provide private, repeatable location independent user experiences, and relieve physical world limitation, such as screen sizes of physical screens.

Embodiments of the present disclosure allow for such portability and security by providing an ecosystem of devices that include AR/VR glasses, an AR/VR glasses mobile clip device 320 for mobile use of the AR/VR glasses with an AR/VR control modular computing device 300 for generating and orchestrating the display of digital content within the AR/VR glasses. In the shown embodiment, the AR/VR glasses are not shown but are understood to be coupled via a retractable and magnetically securable cord 391. Further, the AR/VR glasses mobile clip device 320 may include the retractable and magnetically securable cord 391 retractable within the housing of the AR/VR glasses mobile clip device 320 for connecting the AR/VR glasses to the AR/VR glasses mobile clip device 320. The housing of the AR/MR glasses mobile clip device 320 may be formed to have a clip structure when securely and operatively coupled to the AR/MR control modular computing device 300 such that the AR/MR glasses mobile clip device 320 and operatively coupled to the AR/MR control modular computing device 300 may be worn by a user, such as in a pocket 325 as shown. The AR/VR glasses, as described in embodiments herein, include a secure magnetic connector for slidable attachment and detachment of the retractable and magnetically securable cord 391 from the AR/VR glasses mobile clip device 320 to the AR/VR control modular computing device 300. The AR/VR glasses mobile clip device 320 serves several functions including housing the retracting mechanism of the retractable and magnetically securable cord 391, providing connectivity ports in some embodiments, but also serving as a convenient physical clip for the AR/VR control modular computing device 300 such that it may be wearable or easily hung or placed in flexible locations within a physical user workspace environment. For example, the AR/VR glasses mobile clip device 320 operatively coupled to the AR/VR control modular computing device 300 in an embodiment may then be held in a user's pocket 325, for example, for secure movement of the AR/VR control modular computing device 300 as the user walks.

FIG. 4 is a graphical diagram illustrating an augmented reality/virtual reality (AR/VR) control modular computing device for forming a secure physical connection and a secure data transfer connection with either an AR/VR control modular computing device docking station with augmented computing capabilities or an AR/VR glasses mobile clip device for mobile function, via insertion of a secure mating rail within a secure mating channel, according to an embodiment of the present disclosure. As described herein, the AR/VR control modular computing device 450 in an embodiment may include a secure connector for slidable attachment and detachment of the AR/VR glasses mobile clip device 420 or the AR/VR control modular computing device docking station 450 to the AR/VR control modular computing device 400.

An AR/VR control modular computing device 400 in an embodiment may be disconnected from any other modular devices, clips 420, or docking stations 450 with added computing and port capabilities via an AR/VR control modular computing device secure connector port within a secure mating channel 496 of the AR/VR control modular computing device 400, as shown in FIG. 4. As described herein, the AR/VR control modular computing device 400 in an embodiment may incorporate a secure mating channel 496 for sliding insertion of a secure mating rail 426 or 497 and electrical coupling via a AR/VR control modular computing device secure connector port (not shown) that is actuated by a release button 464. The secure mating channel 496 is formed into one side of the housing of the AR/VR control modular computing device 400 along a side of the housing, such as a flat side as shown, in embodiments herein. The secure mating channel 496 of the AR/VR control modular computing device housing side is formed to indent in the housing of the secure mating channel 496 and sized to slidingly receive a secure mating rail 497 on a housing of a AR/VR control modular computing device docking station 450 or an AR/VR glasses mobile clip device 420. The secure mating rail 497 protrudes from the housing of the AR/VR control modular computing device docking station 450 or an AR/VR glasses mobile clip device 420 and slides horizontally into the secure mating channel 496 relative to the side of the AR/VR control modular computing device 400. The secure mating channel 496 envelopes and securely and operatively couples to the secure mating rail 497 as it slides horizontally into the secure mating channel 496 in embodiments herein. A secure connector pin mount 461b is incorporated within the housing of the AR/VR glasses mobile clip device 420 or a secure connector pin mount 461b within the housing of the AR/VR control modular computing device docking station 450, respectively, to receive the AR/VR control modular computing device secure connector port that is actuated by a release button 464 for electrical coupling or secure physical operative coupling.

In order to mate the AR/VR control modular computing device 400 to either an AR/VR control modular computing device docking station 450 or an AR/VR glasses mobile clip device 420, the user in an embodiment may press down on an AR/VR control modular computing device docking release button 464. This may push a flexible hinge an AR/VR control modular computing device secure connector port downward toward pivot pins of a secure connector pin mount 461a or 461b within the secure mating channel 496, to facilitate securing the secure mating rail 497 or 426 within the secure mating channel 496 after sliding the secure mating rail 497 or 426 into the secure mating channel 496. When wishing to change locations when the AR/VR control modular computing device 400 are currently mated to either an AR/VR control modular computing device docking station 450 or an AR/VR glasses mobile clip device 420, the user may press down on the docking release button 464 housed within the AR/VR control modular computing device 400 and slide the AR/VR control modular computing device 400 away from the currently mated AR/VR control modular computing device docking station 450 or currently mated AR/VR glasses mobile clip device 420, in various embodiments. The AR/VR control modular computing device docking release button 464 with flexible hinge may be spring tensioned such that the AR/VR control modular computing device docking release button 464 has an up position and a down position where the AR/VR control modular computing device secure connector port is engaged with a secure connector pin mount 461a or 461b.

Upon pressing the release button 464 to an down position during mating, the secure mating channel 496 of the AR/VR control modular computing device 400 in an embodiment may continue to slide with respect to secure mating rail 497 or 426, until the secure mating rail 497 or 426 with the secure connector pin mount 461a or 461b, respectively, aligns with a AR/VR control modular computing device secure connector port within the secure mating channel 496. This alignment may allow springs to push a secure connector pin port housing of the AR/VR control modular computing device secure connector port at least partially into a port receiving channel housing the secure connector pin mount 461a or 461b. Insertion or partial insertion of the secure connector pin port housing within the port receiving channel in an embodiment which may inhibit further sliding movement between the secure mating channel 496 and the secure mating rail 497 or 426. In other words, the user may insert the secure mating rail 497 or 426 into the secure mating channel 496 of the AR/VR control modular computing device 400 until the secure connector pin port housing of the AR/VR control modular computing device secure connector port in the secure mating channel 496 drops into place within the port receiving channel housing of the secure connector pin mount 461a or 461b in the secure mating rail 426 or 497. This holds the position of the AR/VR control modular computing device 400 with respect to either the AR/VR glasses mobile clip device 420 or the AR/VR control modular computing device docking station 450, respectively. At this point, the AR/VR control modular computing device 400 is electrically coupled or physically operatively coupled with the AR/VR glasses mobile clip device 420 or the AR/VR control modular computing device docking station 450. In some embodiments, pressing the release button 464 to an up position electrically and physically disengages the AR/VR control modular computing device 400 from the AR/VR glasses mobile clip device 420 or the AR/VR control modular computing device docking station 450 for sliding removal.

FIG. 5A is an exploded view graphical diagram illustrating a stack up of an augmented reality/virtual reality (AR/VR) control modular computing device secure connector port 560 and release button and a secure connector pin mount with a port receiving channel housing according to embodiments of the present disclosure. The components of the AR/VR control modular computing device secure connector port 560 are housed within an AR/VR control modular computing device in an embodiment. The secure connector pin mount is housed within either an AR/VR control modular computing device docking station or an AR/VR glasses mobile clip device for operative physical and electrical coupling of the AR/VR control modular computing device securely with either the AR/VR control modular computing device docking station or the AR/VR glasses mobile clip device according to an embodiment of the present disclosure. For example, the AR/VR control modular computing device docking release button 564, secure connector port anchor 565a, flexible hinge 566a, springs 567, secure connector port cable 568a, and secure connector pin port housing 569a may be disposed within the housing of the AR/VR control modular computing device such that the AR/VR control modular computing device secure connector port is actuated within the secure mating channel of the AR/VR control modular computing device in an embodiment. The secure connector pin mount 561 housing a plurality of secure connector pin contacts 562 and the secure connector pin mount cable 563 may be housed within the secure mating rail of either the AR/VR control modular computing device docking station or the AR/VR glasses mobile clip device. It is contemplated that the AR/VR control modular computing device docking station and the AR/VR glasses mobile clip device contain identical secure connector pin mount 561 hardware and secure mating rail dimensions for mating with the AR/VR control modular computing device interchangeably. Further, although the current disclosure refers to use of a secure mating channel within the AR/VR control modular computing device and a secure mating rail within the AR/VR control modular computing device docking station and AR/VR glasses mobile clip device, it is contemplated that the secure mating rail may be incorporated within the AR/VR control modular computing device for mating with a secure mating channel within the AR/VR control modular computing device docking station or AR/VR glasses mobile clip device in alternative embodiments.

The secure connector port anchor 565a may be fixed in place within the AR/VR control modular computing device at the secure mating channel to allow for movement of the flexible hinge 566a, springs 567, secure connector port cable 568a respect to actuation of the secure connector pin port housing 569a for the AR/VR control modular computing device secure connector port 560 into the secure mating channel to engage with the secure connector pin mount 561 during mating. This actuation of the secure connector pin port housing 569a into the secure mating channel to engage with the secure connector pin mount 561 during mating is described in greater detail below with respect to FIGS. 5C, 5D, 5E, 5F, and 7, below. The secure connector pin port housing 569a of the AR/VR control modular computing device secure connector port 560 that is actuated into the secure mating channel may house a plurality of secure connector pin ports for mating with the secure connector pin contacts 562 within the secure connector pin mount 561 disposed in the secure mating rail in embodiments herein. This is described in greater detail below with respect to FIGS. 5F and 7. The secure connector port cable 568a of the AR/VR control modular computing device secure connector port 560 may be operatively coupled with a bus of the AR/VR control modular computing device in an embodiment for the transfer of power and data between the AR/VR control modular computing device and the AR/VR control modular computing device docking station or AR/VR glasses mobile clip device in various embodiments herein. The secure connector pin mount cable 563 may be operatively coupled via electrically conductive contact with the secure connector pin contacts 562 within the secure connector pin mount 561 and to a bus of the AR/VR control modular computing device docking station, in an embodiment, for the transfer of power and data between the AR/VR control modular computing device and the AR/VR control modular computing device docking station.

FIG. 5B is a top view graphical diagram illustrating an augmented reality/virtual reality (AR/VR) control modular computing device for forming a secure physical connection and a secure data transfer connection with either an AR/VR control modular computing device docking station or an AR/VR glasses mobile clip device according to an embodiment of the present disclosure. FIGS. 5C, 5D, 5E, and 5F below describe various internal components of the secure connection between the AR/VR control modular computing device 500 and either the AR/VR control modular computing device docking station or the AR/VR glasses mobile clip device, as shown in cross-sectional views of two separate portions of the AR/VR control modular computing device 500. The first of these views is shown from the cross-sectional cut across the line A-A, which is disposed behind the AR//VR control modular computing device release button 564, and within the secure mating channel 596. The second of these views is shown from the cross-sectional cut across the line B-B, which is disposed both within the secure mating channel 596 and through the AR/VR control modular computing device release button 564, to show actuation of the release button 564.

FIG. 5C is a cross-sectional view graphical diagram illustrating a portion of an augmented reality/virtual reality (AR/VR) control modular computing device secure connector port 560 for secure connection with either an AR/VR control modular computing device docking station or an AR/VR glasses mobile clip device according to an embodiment of the present disclosure. The cross-section view is disposed beneath an AR/VR control modular computing device docking release button 564 placed in an unlocked and disconnected or up position according to an embodiment of the present disclosure. This cross-sectional view is shown as a cut-away formed by the line B-B in FIG. 5B above, located both within the housing of the AR/VR control modular computing device 500 and through the AR/VR control modular computing device release button 564, to show actuation of the release button 564. The secure mating channel of the housing for the AR/VR control modular computing device 500 is shown as a curved part of the housing at the bottom of the AR/VR control modular computing device secure connector port 560.

When wishing to change locations and the AR/VR control modular computing device 500 is currently mated with a secure mating rail 597 of the AR/VR control modular computing device docking station or the AR/VR glasses mobile clip device, the user may press down on the docking release button 564 housed within the AR/VR control modular computing device 500 to lift the AR/VR control modular computing device secure connector port 560 and slide the AR/VR control modular computing device 500 away from the secure mating rail 597 of the currently mated AR/VR control modular computing device docking station or currently mated AR/VR glasses mobile clip device. Such downward pressure on the docking release button 564 may push a flexible hinge 566a and flexible hinge legs 566b within the housing downward toward pivot pins 565b in the secure connector port anchor 565a. This may cause the flexible hinge legs 566b to rotate and place upward force on pins 569b lifting them against counter springs mounted on pins 569b and lifting the secure connector pin port housing 569a.

FIG. 5D is a cross-sectional view graphical diagram illustrating a portion of an augmented reality/virtual reality (AR/VR) control modular computing device secure connector port 560 within housing of a AR/VR control modular computing device 500 aligned with a secure connector pin mount 561 according to an embodiment of the present disclosure. The AR/VR control modular computing device secure connector port 560 is aligned over a secure mating channel and the secure connector pin mount 561 is formed into a port receiving channel of a secure mating rail 597 in either an AR/VR control modular computing device docking station or an AR/VR glasses mobile clip device according to an embodiment of the present disclosure. The AR/VR control modular computing device secure connector port 560 is placed in an unlocked and disconnected position in the embodiment of FIG. 5D. This cross-sectional view is shown as a cut-away formed by the line A-A in FIG. 5B above, located within the secure mating channel of the housing of the AR/VR control modular computing device 500.

The upward force on the secure connector pin port housing 569a generated when the user presses down on the docking release button (not shown), as described directly above with respect to FIG. 5C may raise the secure connector pin port housing 569a against counter springs 567 and place the bottom edge of the secure connector pin port housing 569a flush or above an interior port opening 596a within the AR/VR control modular computing device secure mating channel, allowing the secure mating rail 597 of the AR/VR glasses mobile clip device to be slidingly interchangeable with the AR/VR control modular computing device docking station 550. The secure mating rail 597 is shown as part of an AR/VR control modular computing device docking station 550 but could also be part of an AR/VR glasses mobile clip device in some embodiments. This sliding interchangeability allows the secure mating rail 597 of the AR/VR control modular computing device docking station to slide into the secure mating channel of AR/VR control modular computing device 500. In an embodiment, the upward force applied to the secure connector pin port housing 569a generated when the user presses down on the docking release button may compress springs situated between the secure connector pin port housing 569a and a secure connector port anchor 565a and push the pin ports 568b out of electrically conductive contact with the pin contacts 562, breaking the electrical circuit between AR/VR control modular computing device 500 and AR/VR glasses mobile clip device or AR/VR control modular computing device docking station 550. The pin contacts 562 are operatively coupled to the secure connector pin mount cable 563 within the housing for the AR/VR control modular computing device docking station 550 or the AR/VR glasses mobile clip device. The force applied to the secure connector pin port housing 569a generated when the user presses down on the docking release button may place the bottom edge of the secure connector pin port housing 569a flush with or above an interior port opening 596a of the secure mating channel of the housing for the AR/VR control modular computing device 500 to allow the secure mating rail 597 of AR/VR glasses mobile clip device or AR/VR control modular computing device docking station 550 to slide out of the secure mating channel in the housing of the AR/VR control modular computing device 500.

FIG. 5E is a cross-sectional view graphical diagram illustrating a portion of an augmented reality/virtual reality (AR/VR) control modular computing device secure connector port 560 for secure connection with either an AR/VR control modular computing device docking station or an AR/VR glasses mobile clip device according to another embodiment of the present disclosure. The cross-section view is disposed beneath an AR/VR control modular computing device docking release button 564 placed in locked and connected position according to an embodiment of the present disclosure. This cross-sectional view is shown as a cut-away formed by the line B-B in FIG. 5B above, located both within the secure mating channel and through the AR/VR control modular computing device release button 564, to show actuation of the release button 564.

The user in an embodiment may release downward force on the AR/VR control modular computing device docking release button 564 to actuate the docking release button in an up position but engaging the AR/VR control modular computing device secure connector port 560 to the secure connector pin mount in the secure mating rail 597 of the AR/VR glasses mobile clip device or AR/VR control modular computing device docking station. The flexible hinge legs 566b within the secure mating channel 596 may no longer apply upward force on the pins 569b of the secure connector pin port housing 569a against counter springs 567. This may allow springs 567 situated between the secure connector pin port housing 569a and a secure connector port anchor 565a having a fixed position with respect to the secure mating channel to push the secure connector pin port housing 569a downward and into contact with secure connector pin mount of the secure mating rail 597 of the AR/VR glasses mobile clip device or AR/VR control modular computing device docking station 550 during mating.

FIG. 5F is a second cross-sectional view graphical diagram illustrating a portion of an augmented reality/virtual reality (AR/VR) control modular computing device secure connector port 560 aligned with a secure connector pin mount 561 in a port receiving channel in a secure mounting rail 597 of either an AR/VR control modular computing device docking station 550 or an AR/VR glasses mobile clip device according to another embodiment herein. The AR/VR control modular computing device secure connector port 560 is placed in a locked and connected position, with the docking release button (not shown) in an up position, to form a secure physical connection and a secure data transfer connection between the AR/VR control modular computing device and either an AR/VR control modular computing device docking station 550 or an AR/VR glasses mobile clip device according to an embodiment of the present disclosure. Although the secure mounting rail 597 is shown as part of an AR/VR control modular computing device docking station 550 in FIG. 5F it could also be part of an AR/VR glasses mobile clip device according other embodiments herein. This cross-sectional view is shown as a cut-away formed by the line A-A in FIG. 5B above, located within the secure mating channel of the AR/VR control modular computing device.

The counter springs 567 situated between the secure connector pin port housing 569a and a secure connector port anchor 565a may push the secure connector pin port housing 569a downward and into a port opening 596a of the secure mating channel 596. The secure connector port anchor 565a has a fixed position relative to the secure mating channel port opening 596a. The AR/VR control modular computing device secure connector port 560 with pin ports 568b within the secure connector pin port housing 569a is pushed downward by the counter springs 567 to engage with the secure connector pin mount 561 in the secure mounting rail 597 of the AR/VR glasses mobile clip device or AR/VR control modular computing device docking station 550 during mating. The secure mating channel in the housing of the AR/VR control modular computing device 500 in an embodiment may continue to slide with respect to secure mating rail 597 until the port opening 596a in the secure mating channel aligns with a port receiving channel 597a in the secure mating rail 597. This alignment may allow the springs 567 situated between the secure connector pin port housing 569a and the secure connector port anchor 565a to push the secure connector pin port housing 569a at least partially into the port receiving channel 597a. Insertion or partial insertion of the secure connector pin port housing 569a within the port receiving channel 597a in an embodiment may inhibit further sliding movement between the secure connector pin port housing 569a and a secure connector pin mount 561 housed within the port receiving channel 597a. In other words, the user may insert the secure mating rail 597 into the secure mating channel 596 of the AR/VR control modular computing device 500 until the secure connector pin port housing 569a of the secure mating channel 596 drops into place within the secure mating rail 597, holding the position of the AR/VR control modular computing device 500 with respect to either the AR/VR glasses mobile clip device or the AR/VR control modular computing device docking station 550 in various embodiments.

The springs 567 situated between the secure connector pin port housing 569a and the secure connector port anchor 565a may push pin contacts 562 within the secure connector pin mount 561 into electrically conductive contact with pin ports 568b within the secure connector pin port housing 569a. Such an electrically conductive contact in an embodiment may complete a power or data transfer connection, such as a Universal Serial Bus (USB-C) connection, for example, between the AR/VR control modular computing device 500 and the secure connector pin mount cable 563 of the AR/VR glasses mobile clip device or AR/VR control modular computing device docking station 550. This mating of the secure mating rail 597 with the secure mating channel when the port receiving channel 597a aligns with the port opening 596a in the secure mating channel 596 of the AR/VR control modular computing device 500 in an embodiment may also form a thermal dissipation pathway for cooling of the AR/VR control modular computing device 500 by the AR/VR control modular computing device cooling docking station 550 in some embodiments, as described in greater detail below with respect to FIG. 8.

Dedicated configuration channel (CC) lines in an embodiment created by at least a portion of the pin contacts 562 coming into electrically conductive contact with at least a portion of the pin ports 568b may allow the AR/VR control modular computing device 500 to authenticate the mated AR/VR glasses mobile clip device or AR/VR control modular computing device docking station 550 via USB-C standard or other proprietary authentication procedures. In such an embodiment in which the AR/VR control modular computing device 500 successfully authenticates the mated AR/VR glasses mobile clip device or mated AR/VR control modular computing device docking station 550, the AR/VR control modular computing device 500 may allow power transfer or transfer of data via the power or data transfer connection, such as a USB-C connection between the AR/VR control modular computing device 500 and the authenticated AR/VR glasses mobile clip device or the authenticated AR/VR control modular computing device docking station 550. In another example embodiment, a hardware processor or controller of the AR/VR control modular computing device cooling docking station 550 may execute machine readable code instructions of an Docking station adaptable cooling system to identify the AR/VR control modular computing device 500 during authentication, via dedicated configuration channel (CC) lines created by at least a portion of the pin contacts 562 coming into electrically conductive contact with at least a portion of the pin ports 568b.

FIG. 6A is a graphical diagram illustrating an augmented reality/virtual reality (AR/VR) glasses mobile clip 620 operably connected to an AR/VR control modular computing device 600 and housing a retractable cable 621 for operably connecting to AR/VR glasses 690 during mobile use of the AR/VR glasses 690 according to an embodiment of the present disclosure. As described herein, using AR/VR glasses 690 allows users to organize a virtual workspace in the space around themselves, projected on top of the real world. Interactions in this workspace use familiar peripherals such as a keyboard, touchpad, and a mouse, for easy adoption and supporting existing applications. AR/VR glasses 690 further allow users to visualize their workspace in a format only viewable by the user themselves, allowing them to work or enjoy media such as a movie in privacy anywhere. Embodiments of the present disclosure allow for such portability and security by providing an ecosystem of devices that include AR/VR glasses 690, an AR/VR glasses mobile clip device 620 for mobile use of the AR/VR glasses 690, and an AR/VR control modular computing device 600 with secure operative coupling to the AR/VR glasses mobile clip device. The AR/VR control modular computing device 600 is a multi-function computing device for generating and orchestrating the display of digital content within the AR/VR glasses 690 and for conducting hardware and software processing with other peripheral devices regardless of whether AR/VR glasses 690 are engaged in various embodiments. Further, the AR/VR glasses mobile clip device 620 may include a retractable and magnetically securable cord 621 for connecting the AR/VR glasses 690 to the AR/VR glasses mobile clip device 620, via a magnetic cord connector 627. The AR/VR glasses mobile clip device 620 also includes a secure connector pin mount as part of the secure mating rail (or secure mating channel) for slidable attachment and detachment of the AR/VR glasses mobile clip device 620 to the AR/VR control modular computing device 600. In some embodiments, the AR/VR glasses mobile clip device 620 and the AR/VR control modular computing device 600 may be of similar width or length to provide a seamless form factor for ease of use and storage as well as for aesthetic purposes.

FIG. 6B is a graphical diagram illustrating an augmented reality/virtual reality (AR/VR) glasses mobile clip 620 operably connected to an AR/VR control modular computing device 600 and housing a retracted and magnetically secured cable 621 for operably connecting to AR/VR glasses in a stowed position according to an embodiment of the present disclosure. The retractable cord 621 may retract into a retractable cord housing 622 within the AR/VR glasses mobile clip device 620 when the AR/VR glasses are disconnected. The outer portion of the retractable cord housing 622 is shown along the edge of the AR/VR glasses mobile clip device 620, but it is contemplated that a retractable spooling device may wind the retractable cord 621 within the housing of the AR/VR glasses mobile clip device 620 in embodiments herein with a channel along the edge of the housing for the AR/VR glasses mobile clip device 620. When disconnected from the AR/VR glasses 690, a magnetic cord connector 627 may magnetically latch to the AR/VR glasses mobile clip device 620 within a magnetic cord connector housing 624 in the channel for ease of storage.

FIG. 6C is a graphical diagram illustrating a carrying case 695 for housing an augmented reality/virtual reality (AR/VR) glasses mobile clip 621, an AR/VR control modular computing device 600, AR/VR glasses 690 according to an embodiment of the present disclosure. The ecosystem of devices that includes AR/VR glasses 690, an AR/VR glasses mobile clip device 620 for mobile use of the AR/VR glasses 690, and an AR/VR control modular computing device 600 may be stored in a single carrying case 695. As described in various embodiments herein, the AR/VR control modular computing device 600 may be portable and multifunctional for generating and orchestrating the display of digital content within the AR/VR glasses 690 or for independent or coordinated use with a plurality of modular input/output devices, one or more standalone display devices, and an AR/VR control modular computing device docking station. The AR/VR glasses mobile clip device 621 and the AR/VR control modular computing device 600 may be securely operatively coupled and are sized in length or width for seamless sizing when mated. The operatively coupled AR/VR glasses mobile clip device 621 and AR/VR control modular computing device 600 may fit within a central holding well of carrying case 695 with AR/VR glasses 690 placed around the sides of the AR/VR glasses mobile clip device 621 and AR/VR control modular computing device 600. The retractable cord is retracted within the AR/VR glasses mobile clip device 621 for storage in the carrying case 695 in embodiments herein.

FIG. 7 is a flow diagram illustrating a method of connecting and disconnecting an augmented reality/virtual reality (AR/VR) control modular computing device with either an AR/VR control modular computing device docking station or an AR/VR glasses mobile clip device, via a secure physical connection and a secure power and data transfer connection according to an embodiment of the present disclosure. As described herein, using AR/VR glasses allows users to organize a virtual workspace in the space around themselves, projected on top of the real world and to visualize their workspace in a format only viewable by the user themselves, allowing them to work or enjoy media such as a movie in privacy anywhere. Embodiments of the present disclosure allow for such portability and security by providing an ecosystem of devices in which a multi-function AR/VR control modular computing device may be easily and efficiently swapped between a mobile usage with AR/VR glasses by a user or enhanced with additional computing NPU or GPU capabilities via engagement with an AR/VR control modular computing device docking station in embodiments herein.

The ecosystem of devices for use with the multi-function AR/VR control modular computing device include AR/VR glasses, an AR/VR glasses mobile clip device for mobile use of the AR/VR glasses, the AR/VR control modular computing device for generating and orchestrating the display of digital content within the AR/VR glasses. The ecosystem of devices also includes the multi-function AR/VR control modular computing device docking station with enhanced hardware computing resources, memory, and other components for use of the multi-function AR/VR control modular computing device with an assortment of desktop peripheral devices such as a standalone display device, physical keyboard, mouse, dial or other I/O devices for independent or coordinated operation with AR/VR glasses. The multi-function AR/VR control modular computing device docking station may provide additional operable connection to additional input/output devices, cooling mechanisms, or external augmented hardware processor devices to increase productivity of the AR/VR control modular computing device. Further, the AR/VR glasses mobile clip device or the multi-function AR/VR control modular computing device docking station may include a secure connector pin mount on a secure mating rail (or in a secure mating channel) for slidable attachment and detachment of the AR/VR glasses mobile clip device or the multi-function AR/VR control modular computing device docking station to the AR/VR control modular computing device. A complimentary AR/VR control modular computing device secure connector port to the secure connector pin mount may be formed within the housing of the AR/VR control modular computing device for actuation into the reciprocal secure mating channel (or on the secure mating rail) provide for slidable attachment and detachment of an AR/VR control modular computing device docking station or to the AR/VR glasses mobile clip device in embodiments herein.

At block 702, the AR/VR control modular computing device secure connector port within a secure mating channel of an AR/VR control modular computing may be in a disconnected from any other modular docking station, AR/VR glasses mobile clip devices, or other modules or peripheral devices in an embodiment. As described herein, the housing of the AR/VR control modular computing device in an embodiment may incorporate a AR/VR control modular computing device secure connector port actuatable into a secure mating channel via a secure connector pin port. The secure mating channel formed in the housing of the AR/VR control modular computing device may slidingly engage with a secure mating rail incorporated within the housing of the AR/VR glasses mobile clip device or the AR/VR control modular computing device docking station slidingly inserted therein.

For example, in an embodiment described with respect to FIG. 4, an AR/VR control modular computing device 400 may be initially disconnected from any other modules, AR/VR glasses mobile clip devices 420, or AR/VR control modular computing device docking station 450. An AR/VR control modular computing device secure connector port within the housing of the AR/VR control modular computing device 400 and actuatable into a secure mating channel 496 of the AR/VR control modular computing device 400 may be disconnected as well. As described herein, the housing of the AR/VR control modular computing device 400 in an embodiment may incorporate a secure mating channel 496 for insertion of a secure mating rail 426 or 497, incorporated within the housing of the AR/VR glasses mobile clip device 420 or the AR/VR control modular computing device docking station 450, respectively.

The user in an embodiment at block 704 may press down on an AR/VR control modular computing device docking release button, pushing a flexible hinge downward toward pivot pins on a secure connector pin port housing within the secure mating channel, causing the flexible hinge legs to rotate and place upward force on a secure connector pin port housing within the AR/VR control modular computing device secure connector port. This causes the secure connector pin port housing of the AR/VR control modular computing device secure connector port to lift away from the secure mating channel. For example, the user may press down on an AR/VR control modular computing device docking release button 464, pushing a flexible hinge downward toward pivot pins on a secure connector pin port housing within the secure mating channel 496, to facilitate sliding of the secure mating rail 497 or 426 within the secure mating channel 496.

At block 706, the upward force on the secure connector pin port housing generated at block 704 may place its bottom edge flush or above a port opening within the AR/VR control modular computing device secure mating channel, allowing the secure mating rail of the AR/VR glasses mobile clip device or docking station to slide into or out of the secure mating channel of AR/VR control modular computing device. For example, in embodiments described with respect to FIGS. 5A, 5B, 5C, 5D, 5E, and 5F, the upward force on the secure connector pin port housing 569a generated when the user presses down on the docking release button may place the bottom edge of the secure connector pin port housing 569a flush with or interior to a port opening 596a within the AR/VR control modular computing device secure mating channel. This actuation of the AR/VR control modular computing device secure connector port 560 of lifting the secure connector pin port housing 569a allows the secure mating rail 597 of the AR/VR glasses mobile clip device or the AR/VR control modular computing device docking station to slide into the secure mating channel below the secure mating channel port opening 596a of AR/VR control modular computing device 500.

The user in an embodiment at block 708 may release downward force on the AR/VR control modular computing device docking release button as the secure mating rail of the AR/VR glasses mobile clip device or docking station slides into the secure mating channel of AR/VR control modular computing device. For example, described with respect to FIGS. 5A, 5B, 5C, 5D, 5E, and 5F, the user in an embodiment may release downward force on the AR/VR control modular computing device docking release button as the secure mating rail 597 of the AR/VR glasses mobile clip device or AR/VR control modular computing device docking station slides into the secure mating channel of the AR/VR control modular computing device 500 to allow counter springs 567 to urge the secure connector pin port housing 569a of the of the AR/VR control modular computing device secure connector port 560 towards port opening 596a in the secure mating channel.

At block 710, with the flexible hinge leg within the AR/VR control modular computing device secure connector port no longer apply upward force on the secure connector pin port housing, counter springs between the secure connector pin port housing and a secure connector port anchor urge the secure connector pin port housing downward and into contact with the AR/VR glasses mobile clip device or docking station secure mating rail during sliding movement. The secure connector pin port housing has a fixed position within the housing of the AR/VR control modular computing device with respect to the secure mating channel enabling a base for the counter springs to push down the secure connector pin port housing. For example, described with respect to FIGS. 5A, 5B, 5C, 5D, 5E, and 5F, the flexible hinge legs 566b within the AR/VR control modular computing device secure connector port 560 may no longer apply upward force on the pins 569b of the secure connector pin port housing 569a. This may allow springs 567 situated between the secure connector pin port housing 569a and a secure connector port anchor 565a having a fixed position with respect to the secure mating channel 596 to push the secure connector pin port housing 569a downward through the port opening 596a and into contact with the AR/VR glasses mobile clip device or AR/VR control modular computing device docking station 550 secure mating rail 597 within the secure mating channel during sliding movement.

The secure mating channel of the AR/VR control modular computing device in an embodiment at block 712 may continue to slide with respect to secure mating rail until the port opening in the secure mating channel aligns with a port receiving channel of a secure connector pin mount in the secure mating rail. For example, in an embodiment described with respect to FIG. 4, the secure mating channel 496 of the AR/VR control modular computing device 400 may continue to slide with respect to secure mating rail 497 or 426, until the secure connector pin mount 461a or 461b within the secure mating rail 497 or 426, respectively, aligns with a secure connector pin port housing of the AR/VR control modular computing device secure connector port at the port opening within the secure mating channel 496. Upon alignment, the springs may further urge the secure connector pin port housing at least partially into a port receiving channel housing the secure connector pin mount 461a or 461b. Insertion or partial insertion of the secure connector pin port housing within the port receiving channel in an embodiment may inhibit further sliding movement between the secure mating channel 496 and either the secure mating rail 497 or 426. In other words, the user may insert the secure mating rail 497 or 426 into the secure mating channel 496 of the AR/VR control modular computing device 400 until the secure connector pin port housing of AR/VR control modular computing device secure connector port drops into place within the secure connector pin port housing of the secure connector pin mount 461 the secure mating rail 426 or 497. This holds the position of the AR/VR control modular computing device 400 with respect to either the AR/VR glasses mobile clip device 420 or the AR/VR control modular computing device docking station 450, respectively.

In other example embodiments described with respect to FIGS. 5A, 5B, 5C, 5D, 5E, and 5F, the secure mating channel of the AR/VR control modular computing device 500 may continue to slide with respect to secure mating rail 597 until the port opening 596a in the secure mating channel aligns with a port receiving channel 597a in the secure mating rail 597. This alignment may allow the springs 567 situated between the secure connector pin port housing 569a and the secure connector port anchor 565a to push the secure connector pin port housing 569a of the AR/VR control modular computing device secure connector port 560 at least partially into the port receiving channel 597a. Insertion or partial insertion of the secure connector pin port housing 569a within the port receiving channel 597a in an embodiment may inhibit further sliding movement between the secure connector pin port housing 569a and a secure connector pin mount 561 housed within the port receiving channel 597a. In other words, the user may insert the secure mating rail 597 into the secure mating channel of the AR/VR control modular computing device 500 until the secure connector pin port housing 569a of the AR/VR control modular computing device secure connector port 560 drops into place within the secure mating rail 597, holding the position of the AR/VR control modular computing device 500 with respect to either the AR/VR glasses mobile clip device or the AR/VR control modular computing device docking station 550 in various embodiments.

At block 714, the springs situated between the secure connector pin port housing and the secure connector port anchor may push pin contacts within the secure connector pin mount of the AR/VR control modular computing device secure connector port into electrically conductive contact with pin ports within the secure connector pin port housing of the secure connector pin mount. For example, the springs 567 situated between the secure connector pin port housing 569a and the secure connector port anchor 565a may push pin contacts 562 within the secure connector pin mount 561 into electrically conductive contact with pin ports 568b within the secure connector pin port housing 569a of the secure connector pin mount 561. Such an electrically conductive contact in an embodiment may complete a power or data transfer connection, such as a Universal Serial Bus (USB-C) connection, for example, between the AR/VR control modular computing device 500 and the AR/VR glasses mobile clip device or AR/VR control modular computing device docking station 550.

In an embodiment at block 716, dedicated configuration channel (CC) lines created by at least a portion of the pin contacts coming into electrically conductive contact with at least a portion of the pin ports may allow the AR/VR control modular computing device to authenticate the mated AR/VR glasses mobile clip device or AR/VR control modular computing device docking station via USB-C standard or other proprietary authentication procedures. For example, dedicated CC lines created by at least a portion of the pin contacts 562 coming into electrically conductive contact with at least a portion of the pin ports 568b may allow the AR/VR control modular computing device 500 to authenticate the mated AR/VR glasses mobile clip device or AR/VR control modular computing device docking station 550 via USB-C standard or other proprietary authentication procedures.

The AR/VR control modular computing device in an embodiment at block 718 may determine whether the mated AR/VR glasses mobile clip device or mated AR/VR control modular computing device docking station has been authenticated. If the AR/VR control modular computing device successfully authenticates the mated AR/VR glasses mobile clip device or mated AR/VR control modular computing device docking station, the method may proceed to block 722 for the exchange of data or power via the power or data transfer connection. If the AR/VR control modular computing device does not successfully authenticate the mated AR/VR glasses mobile clip device or mated AR/VR control modular computing device docking station, the method may proceed to block 720 for the AR/VR control modular computing device to disallow the transfer of data or power via the power or data transfer connection.

At block 720, in an embodiment in which the AR/VR control modular computing device does not successfully authenticate the mated AR/VR glasses mobile clip device or mated AR/VR control modular computing device docking station, the AR/VR control modular computing device may disallow power transfer or transfer of data via the power or data transfer connection, such as a USB-C connection, and log failed attempt at mating. In such a way, the secure connection formed between the AR/VR control modular computing device and either the AR/VR control modular computing device docking station or the AR/VR glasses mobile clip device in various embodiments herein may provide an electronically secure connection. The method may then proceed to block 724 for physical disconnection of the AR/VR control modular computing device from the currently mated AR/VR glasses mobile clip device or currently mated AR/VR control modular computing device docking station.

In an embodiment at block 722 in which the AR/VR control modular computing device successfully authenticates the mated AR/VR glasses mobile clip device or mated AR/VR control modular computing device docking station, the AR/VR control modular computing device may allow power transfer or transfer of data via the power or data transfer connection, such as a USB-C connection between the AR/VR control modular computing device and the authenticated AR/VR glasses mobile clip device or the authenticated AR/VR control modular computing device docking station. For example, in an embodiment in which the AR/VR control modular computing device 500 successfully authenticates the mated AR/VR glasses mobile clip device or mated AR/VR control modular computing device docking station 550, the AR/VR control modular computing device 500 may allow power transfer or transfer of data via the power or data transfer connection, such as a USB-C connection between the AR/VR control modular computing device 500 and the authenticated AR/VR glasses mobile clip device or the authenticated AR/VR control modular computing device docking station 550. In such a way, the secure connection formed by mating of the secure mating channel of the AR/VR control modular computing device and the secure mating rail of either the AR/VR glasses mobile clip device or AR/VR control modular computing device docking station in embodiments herein may provide for secured power and data transfer between mated and authenticated devices.

At block 724, the user may select to press down on AR/VR control modular computing device docking release button. For example, in an embodiment described with respect to FIG. 4, when wishing to change locations or operation with the AR/VR control modular computing device 400, the user may press down on the docking release button 464 housed within the AR/VR control modular computing device 400 to slide the AR/VR control modular computing device 400 away from the currently mated AR/VR control modular computing device docking station 450 or currently mated AR/VR glasses mobile clip device 420, in various embodiments. In other example embodiments described with respect to FIGS. 5A, 5B, 5C, 5D, 5E, and 5F, when wishing to change locations or operation of the AR/VR control modular computing device 500 that is currently mated with the AR/VR control modular computing device docking station 550 or the AR/VR glasses mobile clip device, the user may press down on the docking release button. The docking release button actuates the AR/VR control modular computing device secure connector port 560 housed within the AR/VR control modular computing device 500 to lift a secure connector pin port housing 569a to permit sliding the AR/VR control modular computing device 500 away from the currently mated AR/VR control modular computing device docking station 550 or currently mated AR/VR glasses mobile clip device. Such downward pressure on the docking release button 564 may push a flexible hinge 566a within the secure mating channel 596 downward toward pivot pins 565b in the secure connector port anchor 565a. This may cause the flexible hinge legs 566b to rotate and place upward force on pins 569b to lift the secure connector pin port housing 569a.

In an embodiment at block 726, the upward force applied to the secure connector pin port housing at block 724 may compress the springs situated between the secure connector pin port housing and a secure connector port anchor and push the pin ports out of electrically conductive contact with the pin contacts, breaking the electrical circuit between AR/VR control modular computing device and AR/VR glasses mobile clip device or AR/VR control modular computing device docking station. For example, the upward force applied to the secure connector pin port housing 569a generated when the user presses down on the docking release button may compress springs situated between the secure connector pin port housing 569a and a secure connector port anchor 565a and push the pin ports 568b out of electrically conductive contact with the pin contacts 562, breaking the electrical circuit between AR/VR control modular computing device 500 and AR/VR glasses mobile clip device or AR/VR control modular computing device docking station 550.

At block 728, the force applied to the secure connector pin port housing at block 724 may place its bottom edge flush or interior to the port opening within the AR/VR control modular computing device secure mating channel, allowing the secure mating rail of AR/VR glasses mobile clip device or docking station to slide out of the secure mating channel of AR/VR control modular computing device. For example, the force applied to the secure connector pin port housing 569a generated when the user presses down on the docking release button may place the bottom edge of the secure connector pin port housing 569a flush with or interior to the port opening 596a within the AR/VR control modular computing device secure mating channel, allowing the secure mating rail 597 of AR/VR glasses mobile clip device or AR/VR control modular computing device docking station 550 to slide out of the secure mating channel of the AR/VR control modular computing device 500. The method for securely connecting and disconnecting an AR/VR control modular computing device with either an AR/VR control modular computing device docking station or an AR/VR glasses mobile clip device may then end.

FIG. 8 is a flow diagram illustrating a method of thermally regulating an augmented reality/virtual reality (AR/VR) control modular computing device, via a secure physical connection and secure data transfer connection with an AR/VR control modular computing device docking station having thermal cooling capabilities according to an embodiment of the present disclosure. As described herein, the AR/VR control modular computing device docking station in an embodiment may comprise an AR/VR control modular computing device cooling docking station that uses the thermal pathway formed by the connection between the secure mating rail and the secure mating channel to dissipate heat from the AR/VR control modular computing device and maximize its performance. Upon mating of the secure mating rail of the AR/VR control modular computing device cooling docking station and the secure mating channel of the AR/VR control modular computing device to establish a secure power and data transfer connection, such as described above with respect to FIG. 7, a hardware processor or controller of the AR/VR control modular computing device cooling docking station may execute machine readable code instructions of a docking station adaptable cooling system to operate a thermal control module or additional fans within the AR/VR control modular computing device cooling docking station to cool the AR/VR control modular computing device.

At block 802, the AR/VR control modular computing device in an embodiment may be securely and operatively coupled to an AR/VR control modular computing device cooling docking station via an authenticated data transfer connection, such as via a Universal Serial Bus (USB) C port connection. For example, the AR/VR control modular computing device in an embodiment may be securely and operatively coupled to an AR/VR control modular computing device cooling docking station via an authenticated data transfer connection, as described above with respect to FIG. 7. As described in greater detail below, the physical mechanism by which such a secure data transfer connection for the operative coupling is formed (e.g., mating of the secure connector pin port housing of an AR/VR control modular computing device with the secure connector pin mount of an AR/VR control modular computing device cooling docking station) may also form a thermal pathway through which heat may be transferred between the AR/VR control modular computing device and the AR/VR control modular computing device cooling docking station.

For example, in an embodiment described with respect to FIG. 3D, the AR/VR control modular computing device docking station 350 may be an AR/VR control modular computing device cooling docking station 350 that uses the thermal pathway formed by the operative coupling 361, such as a physical contact, between the AR/VR control modular computing device 300 and the AR/VR control modular computing device cooling docking station 350 to dissipate heat from the AR/VR control modular computing device 350 and maximize its performance. Upon mating of a secure mating rail of the AR/VR control modular computing device cooling docking station 350 within a secure mating channel of the AR/VR control modular computing device 300 and engagement of an AR/VR control modular computing device secure connector port to establish a secure power and data transfer connection, according to embodiments herein, a hardware processor or controller of the AR/VR control modular computing device cooling docking station 350 may execute machine readable code instructions of a docking station adaptable cooling system to operate a thermal control module or additional fans within the AR/VR control modular computing device cooling docking station 350 draw heat from and cool the AR/VR control modular computing device 300. In another example embodiment described with respect to FIG. 5F, this mating of the secure mating rail 597 with the secure mating channel 596 when the port receiving channel 597a aligns with the port opening 596a in the secure mating channel 596 of the AR/VR control modular computing device 500 in an embodiment may form a thermal dissipation pathway for cooling of the AR/VR control modular computing device 500 by the AR/VR control modular computing device cooling docking station 550.

In yet another example embodiment described with respect to FIG. 2, the AR/VR control modular computing device 200 may be securely and operatively coupled to an AR/VR control modular computing device cooling docking station 250, via an authenticated data transfer connection formed through the AR/VR control modular computing device secure connector port 260, such as Universal Serial Bus (USB) C. The physical mechanism by which such a secure data transfer connection is formed within the AR/VR control modular computing device secure connector port 260 may form a thermal pathway through which heat may be transferred between the AR/VR control modular computing device 200 and the AR/VR control modular computing device cooling docking station 250. For example, an air passage may be formed as well as physical contact of thermally conductive elements may be established upon engagement of the AR/VR control modular computing device secure connector port 260.

A hardware processor, hardware controller, or other hardware processing resource of the AR/VR control modular computing device cooling docking station, in an embodiment at block 804, may execute machine readable code instructions of a docking station adaptable cooling system to identify the AR/VR control modular computing device during authentication via dedicated configuration channel (CC) lines in a secure connector. For example, in an embodiment described with reference to FIG. 5F, a hardware processor or hardware controller of the AR/VR control modular computing device cooling docking station 550 in an embodiment may execute machine readable code instructions of a docking station adaptable cooling system to identify the AR/VR control modular computing device 500 during authentication, via dedicated configuration channel (CC) lines created by at least a portion of the pin contacts 562 coming into electrically conductive contact with at least a portion of the pin ports 568b. In an example embodiment described with reference to FIG. 2, a hardware processor 251 or controller 276 of the AR/VR control modular computing device cooling docking station 250 in an embodiment may execute machine readable code instructions 255 of an Docking station adaptable cooling system 273 to identify the AR/VR control modular computing device 200 during authentication, via dedicated configuration channel (CC) lines in the secure connector port 260.

At block 806, the hardware processor or hardware controller of AR/VR control modular computing device cooling docking station in an embodiment may execute machine readable code instructions of the docking station adaptable cooling system to determine an AR/VR control modular computing device preferred operating temperature range, as stored in a profile for the identified AR/VR control modular computing device. For example, the hardware processor 251 or hardware controller 276 of the AR/VR control modular computing device cooling docking station 250 may also execute machine readable code instructions 255 of the docking station adaptable cooling system 273 to determine a preferred operating temperature range for an AR/VR control modular computing device 200, as set by a manufacturer or user and stored in a profile for the identified AR/VR control modular computing device 200 within main memory 252, static memory 253, or memory drive 254.

The hardware processor or controller of the AR/VR control modular computing device cooling docking station in an embodiment at block 808 may execute machine readable code instructions of the docking station adaptable cooling system to request and receive from the AR/VR control modular computing device a temperature reading from a temperature sensor at the AR/VR control modular computing device. For example, the hardware processor 251 or hardware controller 276 of the AR/VR control modular computing device cooling docking station 250 in an embodiment may execute machine readable code instructions 255 of the docking station adaptable cooling system 273 to request and receive from the AR/VR control modular computing device 200 a temperature reading from a temperature sensor at the AR/VR control modular computing device 200.

At block 810, the hardware processor or controller of AR/VR control modular computing device cooling docking station in an embodiment may execute machine readable code instructions of the docking station adaptable cooling system to determine whether the received temperature reading is within the preferred operating temperature range for the identified and authenticated AR/VR control modular computing device. If the received temperature reading is within the preferred operating temperature range for the AR/VR control modular computing device, the method may proceed back to block 808 for routine temperature readings. If the received temperature reading is outside the preferred operating temperature range for the AR/VR control modular computing device, and is cooler than the preferred operating temperature range, the method may proceed to block 812 for disengaging any currently operating thermal control modules or fans. If the received temperature reading is outside the preferred operating temperature range for the AR/VR control modular computing device, and is hotter than the preferred operating temperature range, the method may proceed to block 814 for engaging a thermal control module at the AR/VR control modular computing device docking station to draw heat and cool the AR/VR control modular computing device.

In an embodiment at block 812 in which the received temperature reading is outside the preferred operating temperature range for the AR/VR control modular computing device, and is cooler than the preferred operating temperature range, the hardware processor or controller of the AR/VR control modular computing device cooling docking station may execute machine readable code instructions of the AR/VR control modular computing device cooling docking station adaptable cooling system to turn off a linear flow fan and cease delivery of DC voltage to a thermal control module of the AR/VR control modular computing device docking station. For example, the hardware processor 251 or controller 276 of the AR/VR control modular computing device cooling docking station 250 may execute machine readable code instructions 255 of the AR/VR control modular computing device cooling docking station adaptable cooling system 273 to turn off a linear flow fan 271 and cease delivery of DC voltage to a thermal control module 272. Such a fan 271 and a thermal control module 272 may be used to cool the AR/VR control modular computing device 200, as described directly below. Thus, when the operating temperatures falls below the preferred range, this may indicate that currently engaged fans 271 or thermal control module 272 no longer need to be active. The method may then proceed back to block 808 for routine temperature readings and, if necessary, reinitiation of the fans or thermal control module to cool the AR/VR control modular computing device.

At block 814, in an embodiment in which the received temperature reading is outside the preferred operating temperature range for the AR/VR control modular computing device, and is hotter than the preferred operating temperature range, the hardware processor or hardware controller of the AR/VR control modular computing device cooling docking station may execute machine readable code instructions of the docking station adaptable cooling system to apply direct current (DC) voltage to a thermal control module. The thermal control module 272 in an embodiment may comprise, for example, a Peltier thermoelectric module, or a magnetocaloric material. A magnetocaloric material in an example embodiment may increase or decrease in temperature when a DC voltage is applied to alter the magnetic field of the material. Reorientation of magnetic domains during this process may cause the absorption or release of thermal energy via a magnetocaloric cooling effect. DC voltage may also be applied to a Peltier thermoelectric module to perform a similar method of heat transfer via the secure connector port 260.

Application of DC voltage to the thermal control module may cause heat in an embodiment at block 816 to transfer from the interior of the AR/VR control modular computing device, through the AR/VR control modular computing device secure connector port, to a heat sink operably connected to a secure connector pin mount cable within the secure connector pin mount of the AR/VR control modular computing device docking station. The heat sink may then thermally couple to cooling ribs of the thermal control module, for dissipation to the air surrounding the AR/VR control modular computing device cooling docking station. For example, a Peltier thermoelectric module may comprise two semiconductor elements operatively coupled to a single metal plate on one side (e.g., top), with each of the semiconductor elements also operatively coupled to separate metal plates on the other side (e.g., bottom). Each semiconductor may direct thermal energy in one direction (e.g., either from the top to the bottom or from the bottom to the top), upon application of a DC voltage to the semiconductor. Thus, application of DC voltage to a specific semiconductor element within the Peltier thermoelectric module may cause thermal energy to increase in one direction, which may be toward a heat sink element 274 within the AR/VR control modular computing device cooling docking station 250, drawing thermal energy away from the secure connector port 260 operatively coupled to the heatsink element 274 and cooling the AR/VR control modular computing device 200. The heat sink element 274 in an embodiment may further be operatively and thermally coupled to the cooling ribs 275 having external surfaces on the exterior housing of the AR/VR control modular computing device docking station 250. Heat may thus be transferred from AR/VR control modular computing device 200, though the AR/VR control modular computing device secure connector port 260 and the heatsink element 274, to the cooling ribs 275, and dissipated outward through contact with the air surrounding the AR/VR control modular computing device docking station 250 in an embodiment.

At block 818, following engagement of the thermal control module to cool the AR/VR control modular computing device, the hardware processor or controller of AR/VR control modular computing device cooling docking station in an embodiment may execute machine readable code instructions of the docking station adaptable cooling system to again determine whether the received temperature reading is within the preferred operating temperature range for the identified and authenticated AR/VR control modular computing device. If the received temperature reading is within the preferred operating temperature range for the AR/VR control modular computing device, the method may proceed back to block 808 for routine temperature readings. If the received temperature reading is outside the preferred operating temperature range for the AR/VR control modular computing device, and is cooler than the preferred operating temperature range, the method may proceed to block 812 for disengaging any currently operating thermal control modules or fans. If the received temperature reading is still outside the preferred operating temperature range for the AR/VR control modular computing device, and is still hotter than the preferred operating temperature range, the method may proceed to block 820 for engaging linear flow fan or fans.

At block 820, in an embodiment in which the received temperature reading was still hotter than the preferred operating temperature range for the AR/VR control modular computing device, the hardware processor or hardware controller of the AR/VR control modular computing device cooling docking station may execute machine readable code instructions of the docking station adaptable cooling system to turn on an one or more linear flow fans at the AR/VR control modular computing device docking station to further cool the AR/VR control modular computing device. For example, in an embodiment in which the received temperature reading is still hotter than the preferred operating temperature range for the AR/VR control modular computing device 200, the hardware processor 251 or hardware controller 276 of the AR/VR control modular computing device cooling docking station 250 may execute machine readable code instructions 255 of the docking station adaptable cooling system 273 to turn on one or more linear flow fans 271 to further cool the AR/VR control modular computing device 200. For example, the linear flow fans 271 may operate to cool the AR/VR control modular computing device docking station 250, such as across the cooling ribs 275, to more quickly dissipate heat thermally conducted from the AR/VR control modular computing device 200 via the AR/VR control modular computing device secure connector port 260.

In an embodiment at block 822, the hardware processor or controller of the AR/VR control modular computing device cooling docking station may execute machine readable code instructions of the docking station adaptable cooling system to determine whether the AR/VR control modular computing device is still securely connected to the AR/VR control modular computing device cooling docking station via operative coupling at the AR/VR control modular computing device secure connector port. If the AR/VR control modular computing device is still securely and thermally coupled to the AR/VR control modular computing device cooling docking station via detection of electrical coupling still engaged at the junction of the AR/VR control modular computing device secure connector port and the secure connector pin mount, the method may proceed back to block 808 for routine monitoring of temperatures at the AR/VR control modular computing device. If the AR/VR control modular computing device is no longer securely and thermally coupled to the AR/VR control modular computing device cooling docking station, use of the thermal control module or additional fans to cool the AR/VR control modular computing device may no longer be necessary, and the method of thermally regulating an AR/VR control modular computing device may then end. In such a way, the AR/VR control modular computing device cooling docking station may use the thermal pathway formed by the secure and thermal coupling between the secure mating rail and the secure mating channel via the AR/VR control modular computing device secure connector port to dissipate heat from the AR/VR control modular computing device and maximize its performance.

The blocks of the flow diagrams of FIGS. 7 and 8 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An augmented reality/virtual reality (AR/VR) control modular computing device comprising:
a hardware processor, a network interface device, and a memory disposed in a housing;
the housing including a secure mating channel formed into one side of the housing for slidingly receiving a secure mating channel formed on a housing of an AR/VR control modular computing device docking station or on a housing of an AR/VR glasses clip device;
the hardware processor for executing machine readable code instructions of AR/VR glasses firmware to generate and display AR or VR projected images, via a display projector within operatively coupled AR/VR glasses; and
a secure connector port spring-loaded and partially disposed within a port opening in the secure mating channel for actuation into the secure mating channel such that vertical alignment between the port opening and the port receiving channel of the secure connector pin mount in the secure mating rail forces movement of the secure connector pin port housing to operatively couple with the secure connector pin mount to electrically and communicatively couple the AR/VR control modular computing device to the AR/VR control modular computing device docking station or to the AR/VR glasses mobile clip device for power and data transfer.

2. The AR/VR control modular computing device of claim 1, wherein the secure connector port spring-loaded to actuate into the port opening in the secure mating channel to electrically and operatively couple to the secure connector pin mount in the secure mating rail further establishes a thermal dissipation pathway for the transfer of heat from the AR/VR control modular computing device to a heat sink of the AR/VR control modular computing device docking station.

3. The AR/VR control modular computing device of claim 1, wherein the secure connector pin port housing of the secure connector port operatively coupled with the secure connector pin mount of the AR/VR control modular computing device docking station operatively couples the AR/VR control modular computing device to an additional hardware processor of the AR/VR control modular computing device docking station to increase computing power of the AR/VR control modular computing device.

4. The AR/VR control modular computing device of claim 1, wherein the secure connector port includes secure connector pin contacts electrically and operatively coupled with electrically conductive contact with pin ports of the secure connector pin mount in the secure mating rail with a subset of the plurality of the secure connector pin contacts and the pin ports in electrically conductive contact forming dedicated configuration channel lines reserved for authentication of the AR/VR control modular computing device docking station to the AR/VR control modular computing device or vice-versa.

5. The AR/VR control modular computing device of claim 1, wherein the secure connector pin port housing of the secure connector port operatively coupled with the secure connector pin mount of the AR/VR control modular computing device docking station operatively couples the AR/VR control modular computing device to one or more input/output devices that are also operatively coupled to the AR/VR control modular computing device docking station.

6. The AR/VR control modular computing device of claim 1, wherein the secure connector pin port housing of the secure connector port operatively coupled with the secure connector pin mount of the AR/VR control modular computing device docking station operatively couples the AR/VR control modular computing device to one or more input/output devices that are also operatively coupled to the AR/VR control modular computing device docking station.

7. The AR/VR control modular computing device of claim 1, wherein the secure connector pin port housing of the secure connector port operatively coupled with the secure connector pin mount of the AR/VR glasses mobile clip device operatively couples the AR/VR control modular computing device to the AR/VR glasses via a magnetically securable cord from the AR/VR glasses mobile clip device to the AR/VR glasses during mobile use.

8. The AR/VR control modular computing device of claim 1 further comprising:
the AR/VR control modular computing device housing having a docking release button disposed therein that, when in a depressed position, causes a flexible hinge to pull the secure connector pin port housing out of the port receiving channel, allowing horizontal movement for sliding of the secure mating rail out of the secure mating channel to physically disconnect the AR/VR control modular computing device from the AR/VR glasses mobile clip device or AR/VR control modular computing device docking station.

9. An augmented reality/virtual reality (AR/VR) control modular computing device cooling docking station comprising:
a docking station hardware processor, a docking station network interface device, and a memory disposed in a housing of the AR/VR control modular computing device cooling docking station;
the housing having a secure mating rail formed onto a surface of the housing with a secure connector pin mount on the secure mating rail for sliding insertion within a secure mating channel of a housing for an AR/VR control modular computing device that includes a secure connector pin port housing for operatively coupling to the secure connector pin mount, wherein the AR/VR control modular computing device generates AR or VR projected images for display via AR/VR glasses operatively coupled to the AR/VR control modular computing device cooling docking station via a cord;
the secure mating rail having a port receiving channel of the secure connector pin mount for receiving the secure connector pin port housing when the port receiving channel aligns vertically with a port opening in the secure mating channel of the AR/VR control modular computing device to electrically and communicatively couple and form a thermal dissipation pathway between the AR/VR control modular computing device and the AR/VR control modular computing device cooling docking station when pin contacts of the secure connector pin mount are placed in electrically conductive contact with pin ports of the secure connector pin port housing;
a docking station hardware controller executing machine readable code instructions of a docking station adaptable cooling system to determine a preferred operating temperature range for the AR/VR control modular computing device and to receive a temperature reading from a temperature sensor in the AR/VR control modular computing device;
the docking station hardware controller for executing machine readable code instructions to determine that the temperature reading is higher than the preferred operating temperature range and to apply a direct current (DC) voltage to a thermal control module to cause heat transfer from the interior of the AR/VR control modular computing device to a heat sink of the AR/VR control modular computing device cooling docking station, via the thermal dissipation pathway with the secure connector pin mount; and
the heat sink operably coupled for dissipation of heat from thermal dissipation pathway with the AR/VR control modular computing device to air surrounding the AR/VR control modular computing device cooling docking station to cool the AR/VR control modular computing device.

10. The AR/VR control modular computing device cooling docking station of claim 9 further comprising:
a wired communication port for establishing a wired data transfer connection between the AR/VR glasses and the AR/VR control modular computing device cooling docking station for the transfer of machine readable code instructions received from the AR/VR control modular computing device, via the secure connector pin mount, directing the display of generated AR/VR images at the AR/VR glasses.

11. The AR/VR control modular computing device cooling docking station of claim 9 further comprising:
a plurality of the pin contacts and a plurality of the pin ports for coming into electrically conductive contact to form dedicated configuration channel lines reserved for authentication of the AR/VR control modular computing device.

12. The AR/VR control modular computing device cooling docking station of claim 9, wherein vertical alignment of the port receiving channel and the secure connector pin port housing that is spring loaded to urge the secure connector pin port housing into the secure mating channel and insertion of the secure connector pin port housing at least partially within the port receiving channel inhibits horizontal movement between secure mating channel of the AR/VR control modular computing device and the secure mating rail of the AR/VR control modular computing device cooling docking station.

13. The AR/VR control modular computing device cooling docking station of claim 9, wherein the thermal control module includes a Peltier thermoelectric module or a magnetocaloric material that changes its magnetic field and cools in response to an applied voltage.

14. An augmented reality/virtual reality (AR/VR) control modular computing device comprising:
a hardware processor, a network interface device, and a memory disposed in a housing the housing including a secure mating channel formed into one side of the housing for slidingly receiving a secure mating channel formed on a housing of an AR/VR control modular computing device docking station or on a housing of an AR/VR glasses clip device;
the hardware processor for executing machine readable code instructions of AR/VR glasses firmware to generate and display AR or VR projected images, via a display projector within operatively coupled AR/VR glasses; and
a secure connector port spring-loaded and partially disposed within a port opening in the secure mating channel for actuation into the secure mating channel such that vertical alignment between the port opening and the port receiving channel of the secure connector pin mount in the secure mating rail forces movement of the secure connector pin port housing with pin contacts to electrically and operatively couple via electrically conductive contact with pin ports of the secure connector pin mount to electrically and communicatively couple the AR/VR control modular computing device to the AR/VR control modular computing device docking station or to the AR/VR glasses mobile clip device for power and data transfer, wherein a subset of the pin contacts and the pin ports in electrically conductive contact form dedicated configuration channel lines reserved for authentication of the AR/VR control modular computing device docking station or the AR/VR glasses mobile clip to the AR/VR control modular computing device.

15. The AR/VR control modular computing device of claim 14, wherein the secure connector port spring-loaded to actuate into the port opening in the secure mating channel to electrically and operatively couple to the secure connector pin mount in the secure mating rail further establishes a thermal dissipation pathway for the transfer of heat from the AR/VR control modular computing device to a heat sink of the AR/VR control modular computing device docking station.

16. The AR/VR control modular computing device of claim 14, wherein the secure connector pin port housing of the secure connector port operatively coupled with the secure connector pin mount of the AR/VR control modular computing device docking station operatively couples the AR/VR control modular computing device to an additional hardware processor of the AR/VR control modular computing device docking station to increase computing power of the AR/VR control modular computing device.

17. The AR/VR control modular computing device of claim 14, wherein the secure connector pin port housing of the secure connector port operatively coupled with the secure connector pin mount of the AR/VR control modular computing device docking station operatively couples the AR/VR control modular computing device to one or more input/output devices that are also operatively coupled to the AR/VR control modular computing device docking station.

18. The AR/VR control modular computing device of claim 14, wherein the secure connector pin port housing of the secure connector port operatively coupled with the secure connector pin mount of the AR/VR control modular computing device docking station operatively couples the AR/VR control modular computing device to one or more input/output devices that are also operatively coupled to the AR/VR control modular computing device docking station.

19. The AR/VR control modular computing device of claim 14, wherein the secure connector pin port housing of the secure connector port operatively coupled with the secure connector pin mount of the AR/VR glasses mobile clip device operatively couples the AR/VR control modular computing device to the AR/VR glasses via a magnetically securable cord from the AR/VR glasses mobile clip device to the AR/VR glasses during mobile use.

20. The AR/VR control modular computing device of claim 14 further comprising:
the AR/VR control modular computing device housing having a docking release button disposed therein that, when in a depressed position, causes a flexible hinge to pull the secure connector pin port housing out of the port receiving channel, allowing horizontal movement for sliding of the secure mating rail out of the secure mating channel to physically disconnect the AR/VR control modular computing device from the AR/VR glasses mobile clip device or AR/VR control modular computing device docking station.
